(19) United States
(12) Patent Application Publication
(10) Pub. No.: US 2026/0109479 A1
(43) Pub. Date: Apr. 23, 2026

(54) Utility Pit

(71) Applicant: 4Mile Fueling, LLC, Dover, DE (US)

(72) Inventors: Rennie John Crisafulli, Arlington, TX (US); Josh Edward Crisafulli, Arlington, TX (US); Jordan Patrick Maun, Mansfield, TX (US); Thomas Scott Baldwin, Houston, TX (US); Michael Lamont Riggs, Tulsa, OK (US)

(21) Appl. No.: 19/327,342

(22) Filed: Sep. 12, 2025

Related U.S. Application Data
(60) Provisional application No. 63/694,621, filed on Sep. 13, 2024.

(51) Int. Cl. B64F 1/28; E02D 29/14

(52) U.S. Cl. CPC B64F 1/28; E02D 29/14

(57) ABSTRACT

In one or more illustrative arrangements, a utility pit system is presented that includes an inlet system that may be formed primarily of high-density polyethylene (HDPE). In one or more illustrative arrangements, the system includes a main pit that may be formed primarily of HDPE. In one or more illustrative arrangements, the system includes an outlet system that may be formed primarily of HDPE. In one or more illustrative arrangements, the inlet system is configured to operably connect to the main pit by any means of HDPE connection and thereby may form a hermetic or nearly hermetic seal. In one or more illustrative arrangements, the outlet system is configured to operably connect to the main pit by any means of HDPE connection and thereby may form a hermetic or nearly hermetic seal. In one or more illustrative arrangements, the system is configured to retain a liquid material therein.

### CROSS REFERNCE TO RELATED PATENT APPLICATIONS

This application claims priority to U.S. Provisional Patent Application No. 63/694,621, titled “HYDRANT PIT” filed on Sep. 13, 2024, the entirety of which is hereby incorporated by reference herein.

### FIELD OF THE DISCLOSURE

This disclosure relates to a utility pit. More specifically, this disclosure relates to utility pits for use in aviation, railroads, energy, and various other industries and applications without limitation unless otherwise indicated in the following claims.

### OVERVIEW OF THE DISCLOSURE

In order to increase the efficiency of fueling operations, airports, railroad station, and locations in various other industries may require underground utility pits (also referred to as hydrant pits in certain applications) to store or route utilities (e.g., fuel, water, electrical) or other materials, and/or house valves, connections, and/or other equipment related to such utilities materials (e.g., for refueling aircraft or other vehicles using hydrant fuel systems). In one or more illustrative arrangements, as examples, utility pits may be present at airport gates in order for aircraft to have readily accessible fuel to increase efficiency of fueling operations and turnaround times for airplanes parked at the gates. In one or more alternative arrangements, as examples, utility pits may be present at railroad stations, rail yards, industrial tank farms, other fueling locations, or in any other suitable location wherein one or more features of the present disclosure may be desirable. In the past, utility pits have been constructed primarily of metal and/or fiberglass. These utility pits are difficult and dangerous to clean. Additionally, these pits are difficult to service and repair if they get a puncture, crack, hole, defect, or other disadvantageous anomaly and/or damage. If a utility pit requires such a service or repair, fuel first must be drained from the pit. In some instances, the pit may be fixed while still underground. However, in other instances, the pit may need to be removed for repairs and/or maintenance.

In order to fix a relatively small defect and/or anomaly in a metal utility pit, portions around the anomaly must be cut out, then a replacement piece of metal must be welded to the existing structure. To fix a larger anomaly, entire metal panels may need to be removed from the existing structure, then new panels must be welded onto the remaining portion of the existing structure. Generally, as used herein “defect,” “damaged portion,” “anomaly” and/or similar terms may be used interchangeably to refer to any aspect of a utility pit or portion thereof that that causes suboptimal performance of the utility pit and/or prevents the utility pit from functioning as designed without limitation unless otherwise indicated in the following claims.

Fiberglass pits are rarely fixable. In some instances, small defects in fiberglass pits can be patched by using a resin or filler, however defects in fiberglass are rarely small. That is, in most instances where a fiberglass pit is damaged, the damage causes issues with too large of portions to be fixed by resin or filler. Therefore, often times when a fiberglass pit is damaged or a defect is found, the pit must be replaced entirely. This is especially true when airports are being constructed and utility pits are being installed. The construction and install process for fiberglass utility pits presents many hazards and opportunities for accidental damage to the fiberglass utility pit, and often times numerous pits must be repurchased during the construction and installation process because the originally purchased pit is damaged during construction.

Therefore, for all the reasons stated above, and the reasons stated below, there is a need in the art for an improved utility pit that is more resistant to defects and/or damage, and which utility pit is easier to fix when they occur. Thus, it is a primary objective of the disclosure to provide a utility pit that improves upon the state of the art.

Another objective of the disclosure is to provide a utility pit which is durable.

Yet another objective of the disclosure is to provide a utility pit which is easy to install.

Another objective of the disclosure is to provide a utility pit which is easy to repair.

Yet another objective of the disclosure is to provide a utility pit which is inexpensive to repair.

Another objective of the disclosure is to provide a utility pit which is safe to repair.

Yet another objective of the disclosure is to provide a utility pit which is safe to clean.

Another objective of the disclosure is to provide a utility pit which is relatively easy to clean.

Yet another objective of the disclosure is to provide a utility pit which is relatively easy and inexpensive to build.

Another objective of the disclosure is to provide a utility pit which can be built relatively quickly and efficiently.

Yet another objective of the disclosure is to provide a utility pit which is relatively cost friendly to manufacture.

Another objective of the disclosure is to provide a utility pit which is relatively easy to transport.

Another objective of the disclosure is to provide a utility pit which is robust.

Yet another objective of the disclosure is to provide a utility pit which is water resistant.

Another objective of the disclosure is to provide a utility pit which is cost effective.

Yet another objective of the disclosure is to provide a utility pit which is not easily susceptible to wear and tear.

Another objective of the disclosure is to provide a utility pit which has a long useful life. Yet another objective of the disclosure is to provide a utility pit which is efficient to use and operate.

These and other objects, features, or advantages of the disclosure will become apparent from the specification, figures, and claims.

### SUMMARY OF THE DISCLOSURE

In one or more arrangements, a utility pit system is presented. In one or more arrangements, the system includes an inlet system formed primarily of high-density polyethylene (HDPE). In one or more arrangements, the system includes a main pit formed primarily of HDPE. In one or more arrangements, the system includes an outlet system formed primarily of HDPE. In one or more arrangements, the inlet system is configured to operably connect to the main pit by any means of HDPE connection. In one or more arrangements, the outlet system is configured to operably connect to the main pit by any means of HDPE connection. In one or more arrangements, the system is configured to retain fuel or other material therein. However, other configurations of the system may be differently configured and/or designed for other applications without limitation unless otherwise indicated in the following claims.

### BRIEF DESCRIPTION OF THE FIGURES:

FIG. 1 is an overview of an airplane taxi area, two separate airplanes, fuel tanks, and certain fueling components, including an illustrative embodiment of a utility pit system, shown underneath the fuel tanks and airplanes, which may be underground, and which may be one illustrative application for the utility pit system.

FIG. 2 is a detailed right-side view of an illustrative embodiment of a utility pit system shown in FIGS. 1 & 1A showing an illustrative arrangement of a main pit, outlet system, and inlet system.

FIG. 3 is a detailed left-side view of an illustrative embodiment of a utility pit system that may be used in the application shown in FIGS. 1 & 1A.

FIG. 4 is a detailed back-side view of an illustrative embodiment of a utility pit system shown in FIG. 3.

FIG. 5 is a detailed front-side view of an illustrative embodiment of a utility pit system shown in FIG. 5.

FIG. 6 is a detailed top-side view of an illustrative embodiment of a utility pit system shown in FIG. 3.

FIG. 7 is another detailed top-side view of an illustrative embodiment of a utility pit system shown in FIG. 3.

FIG. 8 is a detailed perspective view of an illustrative embodiment of a utility pit system shown in FIG. 3.

FIG. 9 is a detailed perspective view of a portion of the illustrative embodiment of a utility pit shown in FIG. 3 adjacent to an illustrative embodiment of an outlet system that may be used with various embodiments of the utility pit system disclosed herein.

FIG. 10 is a vertical cross-sectional view of the illustrative embodiment of a utility pit system shown in FIG. 3.

FIG. 11 is a detailed right-side view of another illustrative embodiment of a utility pit system that may be used in various applications as described herein showing an illustrative arrangement of a main pit, outlet system, and inlet system.

FIG. 12 is detailed left-side view of the illustrative embodiment of a utility pit system shown in FIG. 11.

FIG. 13 is a detailed back-side view of the illustrative embodiment of a utility pit system shown in FIG. 11.

FIG. 14 is a detailed front-side view of the illustrative embodiment of a utility pit system shown in FIG. 11.

FIG. 15 is a detailed top-side view of the illustrative embodiment of a utility pit system shown in FIG. 11.

FIG. 16 is a detailed bottom-side view of the illustrative embodiment of a utility pit system shown in FIG. 11.

FIG. 17 is a detailed perspective view of the illustrative embodiment of a utility pit system shown in FIG. 11.

FIG. 18 is a detailed perspective view of a portion of the illustrative embodiment of a utility pit shown in FIG. 11 adjacent to an illustrative embodiment of an outlet system that may be used with various embodiments of the utility pit system disclosed herein.

FIG. 19 is a vertical cross-sectional view of the illustrative embodiment of a utility pit system shown in FIG. 11.

FIG. 20 is a detailed perspective view of another illustrative embodiment of a utility pit system having a different illustrative arrangement of an outlet system.

FIG. 21 is a detailed perspective view of another illustrative embodiment of a utility pit system having the illustrative arrangement of an outlet system as shown in FIG. 20 but with a different illustrative arrangement of an inlet system.

FIG. 22 is a detailed perspective view of another illustrative embodiment of a utility pit system having the illustrative arrangement of an outlet system as shown in FIGS. 20 and 21 but with a different illustrative arrangement of an inlet system.

FIG. 23 is another detailed perspective view of the illustrative embodiment of a utility pit system shown in FIG. 22 wherein a portion of the side of the utility pit system is shown as transparent for purposes of explanation.

FIG. 24 is a detailed cross-sectional view of an illustrative embodiment of various material handling components that may be used with various illustrative embodiments of the utility pit system.

FIG. 25 is a perspective view of an illustrative embodiment of a manhole cover that may be used with various embodiments of the utility pit system.

FIG. 26A is a cross-sectional view of a portion of the illustrative embodiment of a manhole cover shown in FIG. 25

FIG. 26B is a detailed cross-sectional view of a portion of the bottom side of the illustrative embodiment of a manhole cover shown in FIG. 25.

FIG. 27 is a perspective view of an illustrative embodiment of a ring that may be used with various embodiments of a manhole cover and/or utility pit system.

FIG. 28 is an elevated perspective view of another illustrative embodiment of utility pit system that may be used in the application shown in FIGS. 1 & 1A.

FIG. 29 is another perspective view of the illustrative embodiment of utility pit system shown in FIG. 28.

FIG. 30 is a front view of the illustrative embodiment of utility pit system shown in FIG. 28.

FIG. 31 is a back view of the illustrative embodiment of utility pit system shown in FIG. 28.

FIG. 32 is a left side view of the illustrative embodiment of utility pit system shown in FIG. 28.

FIG. 33 is a right side view of the illustrative embodiment of utility pit system shown in FIG. 28.

FIG. 34 is a top view of the illustrative embodiment of utility pit system shown in FIG. 28.

FIG. 35 is a bottom view of the illustrative embodiment of utility pit system shown in FIG. 28.

FIG. 36 is a cross-sectional view of the illustrative embodiment of utility pit system shown in FIG. 28 about a vertical plane oriented parallel with respect to planar exterior of inlet system 18.

FIG. 37 is another cross-sectional view of the illustrative embodiment of utility pit system shown in FIG. 28 about a vertical plane oriented perpendicular with respect to planar exterior of inlet system 18.

FIG. 38 is another top view of the illustrative embodiment of utility pit system shown in FIG. 28.

FIG. 39 is a detailed view of a portion of the illustrative embodiment of utility pit system shown in FIG. 28 adjacent the outlet system.

FIG. 40 is another detailed view of a portion of the illustrative embodiment of utility pit system shown in FIG. 28 adjacent the outlet system.

### DETAILED DESCRIPTION OF THE DISCLOSURE

In the following detailed description of the embodiments, reference is made to the accompanying drawings which form a part hereof, and in which is shown by way of illustration specific and illustrative embodiments in which the disclosure may be practiced. The embodiments of the present disclosure described herein and below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the present disclosure. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any specific advantages and/or improvements discussed herein may not be provided by various disclosed embodiments, or implementations thereof. The claimed embodiments are not so limited and should not be interpreted as being restricted to embodiments which provide such advantages or improvements. Similarly, it should be understood that various embodiments may not address all or any objects of the disclosure or objects of the illustrative embodiments that may be described herein. The claimed embodiments are not so limited and should not be interpreted as being restricted to embodiments that address such objects of the disclosure or illustrative embodiments. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure without limitation unless otherwise indicated in the following claims.

It is to be understood that the terms such as “left,” “right,” “top,” “bottom,” “front,” “back,” “side,” “height,” “length,” “width,” “upper,” “lower,” “interior,” “exterior,” “inner,” “outer,” and the like as may be used herein, and merely describe points of reference and do not limit the present disclosure to any particular orientation or configuration unless otherwise indicated in the following claims.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or”combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably,” such as when used as “operatively connected” or “operably engaged” is to be interpreted as connected or engaged, respectively, in any manner that facilitates operation, which may include being directly connected, indirectly connected, electronically connected, wirelessly connected, or connected by any other manner, method, or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of the fuel utility pits for aviation and railroad applications, but without limitation to the particular application of the utility pit and/or the material for which the utility pit is designed unless otherwise indicated in the following claims. Accordingly, the embodiments are not so limited, and it will be appreciated by those skilled in the art that the embodiments may be adapted for use in other applications that may be improved by the disclosed structures, arrangements, and/or methods. The system is merely shown and described as being used in the context of fuel utility pits for aviation and railroad applications for ease of description and as one of countless examples.

### Utility Pit System

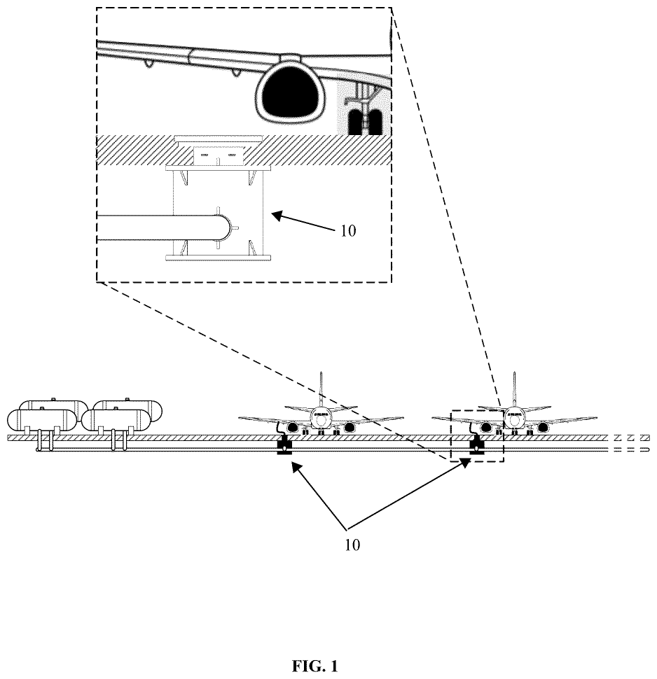

With reference to the figures, a utility pit system 10 (or simply “system 10”) is presented. System 10 is formed of any suitable size, shape, and design is configured to contain fuel or other material (e.g., other liquid material such as water, other material that may be fluidized such as powders, granules, etc.) at airport gates, railroad stations, rail yards, and/or other locations in order to quickly and efficiently supply fuel and/or other material (e.g., other liquid material such as water, other material that may be fluidized such as powders, granules, etc.) to airplanes, trains, and/or other material to other destinations. For illustrative purposes, system 10 is depicted in an airport application in FIG. 1, but as previously stated, system 10 may be deployed in any suitable application/environment without limitation unless otherwise indicated in the following claims.

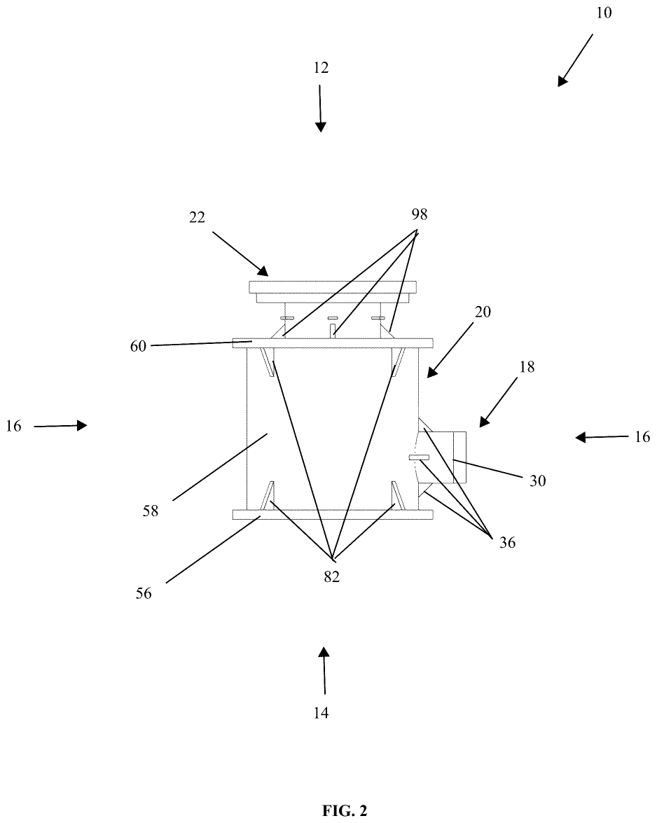

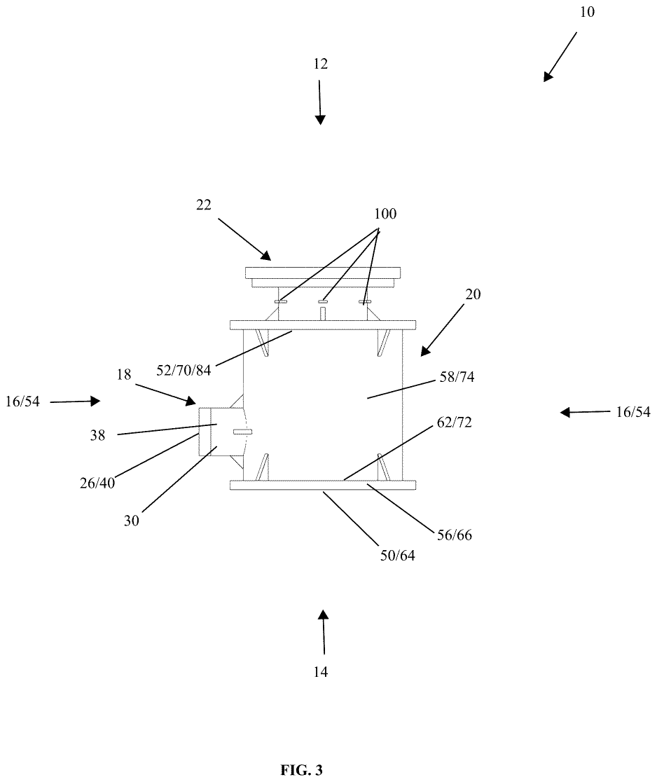

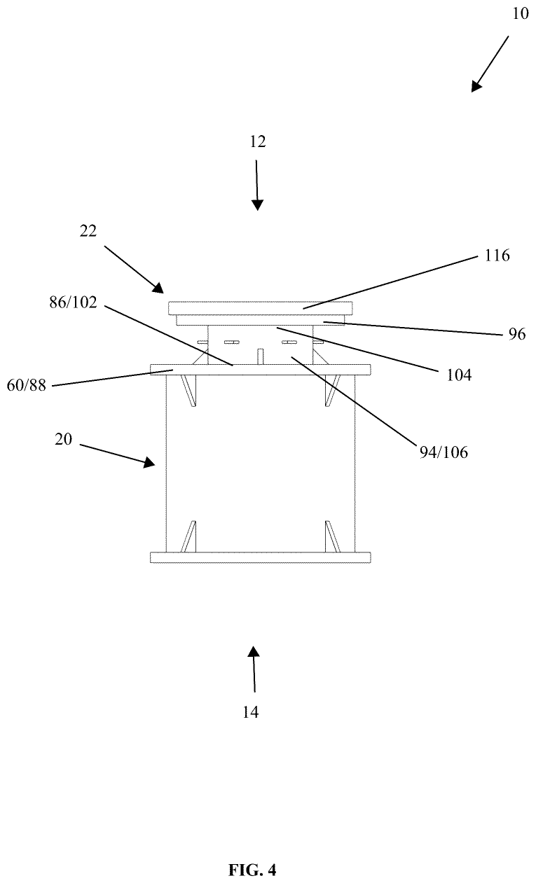

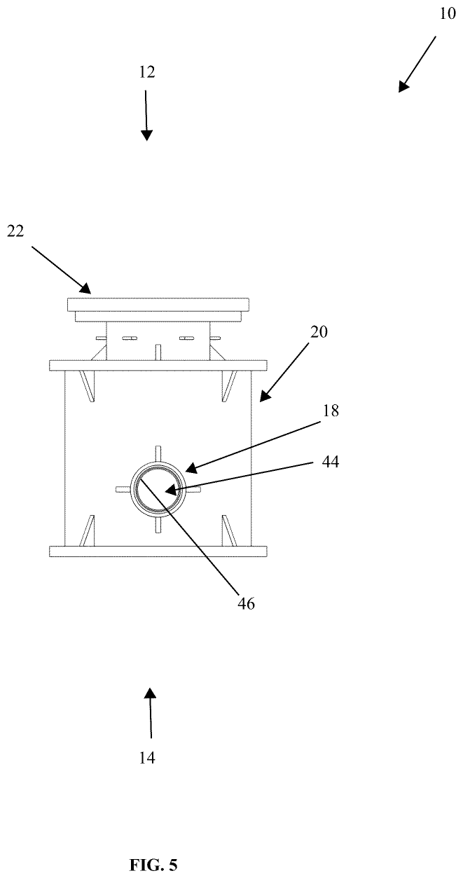

In the illustrative arrangement shown in FIG. 2, as one example, system 10 includes a top end 12, a bottom end 14, and opposing left and right sides 16 (or simply “sides 16”). In the illustrative arrangement shown, as one example, system 10 includes an inlet system 18, a main pit 20, and an outlet system 22, among other components as are described herein. In the illustrative arrangement shown, as one example, system 10 is generally cylindrical in shape, which allows for system 10 to be easily scalable in size, allow for more flexibility to meet specific demands of the location where system 10 is being installed, and provide field operators more space to easily access and repair system 10. Alternatively, in other arrangements, as examples, system 10 may be any other shape, layout, or design without limitation unless otherwise indicated in the following claims as needed or desired for the location or application for which system 10 is installed or being installed without limitation unless otherwise indicated in the following claims. While system 10 has been described according to the arrangements shown, as one example, any combination or arrangement may be used and is hereby contemplated for use.

### Inlet System 18

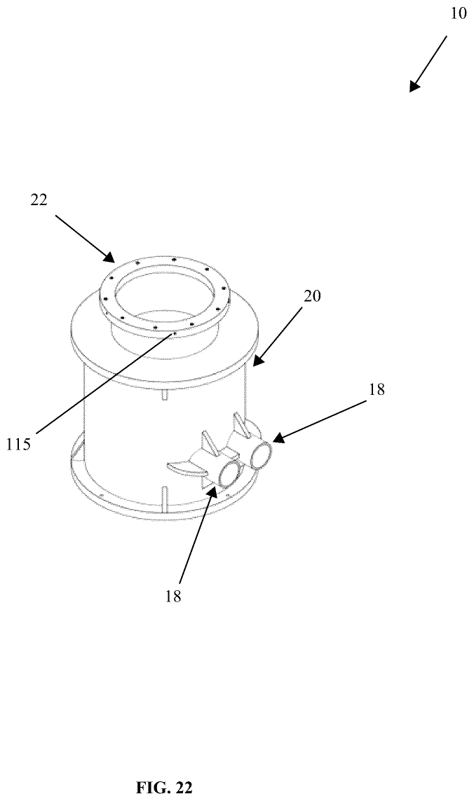

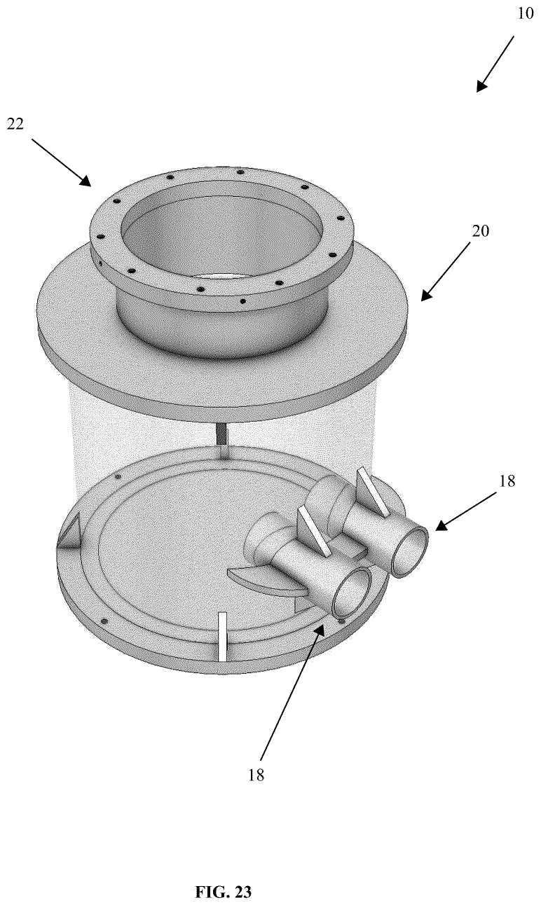

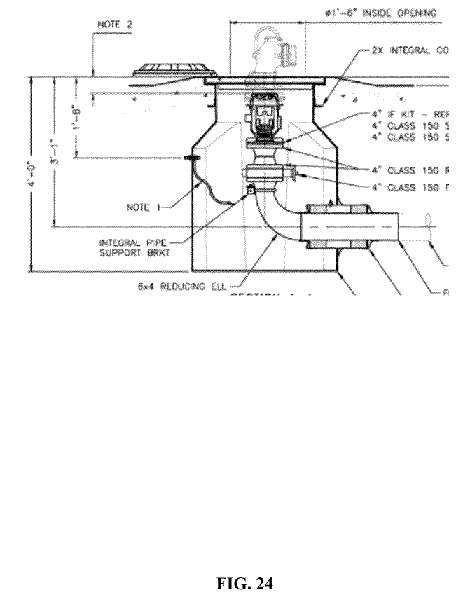

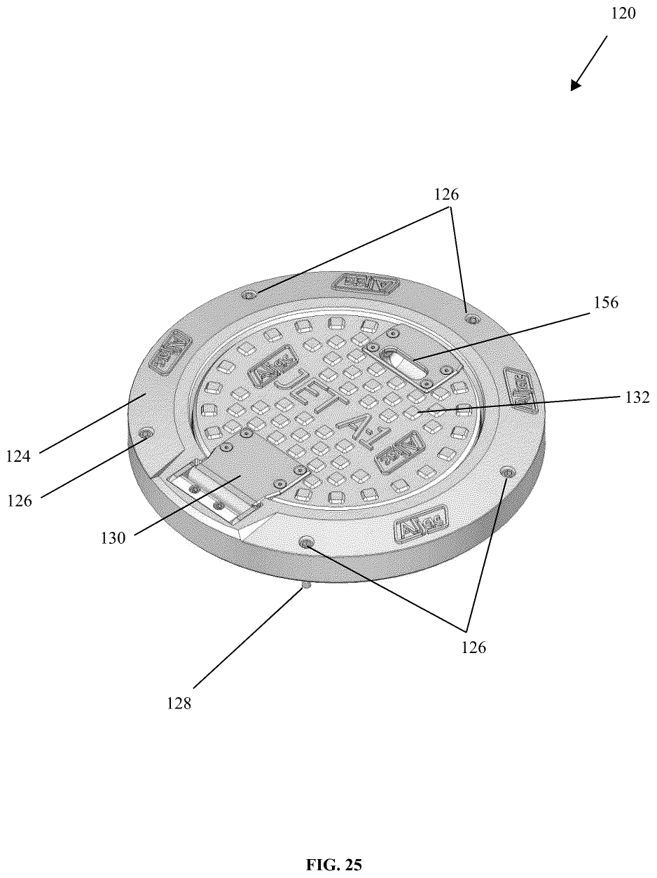

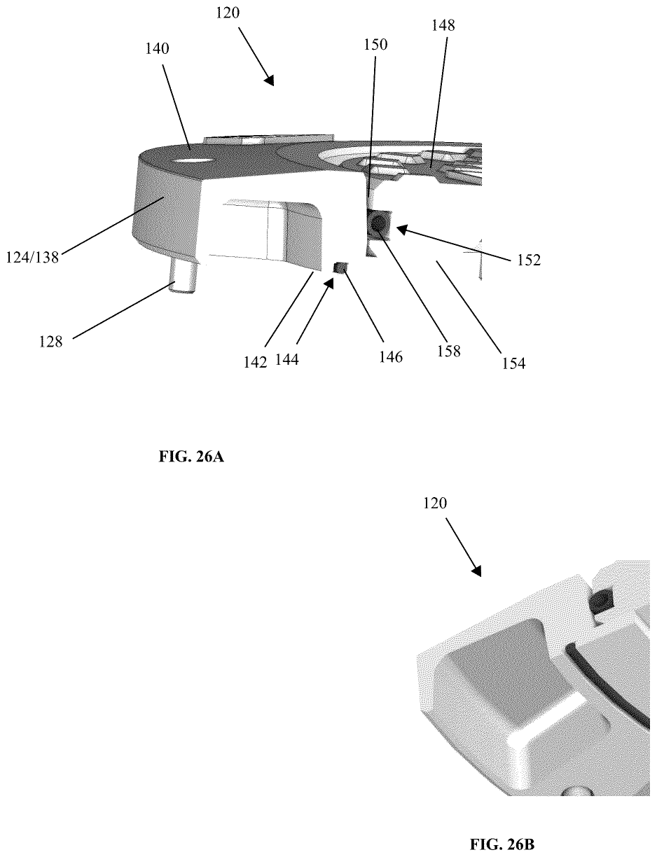

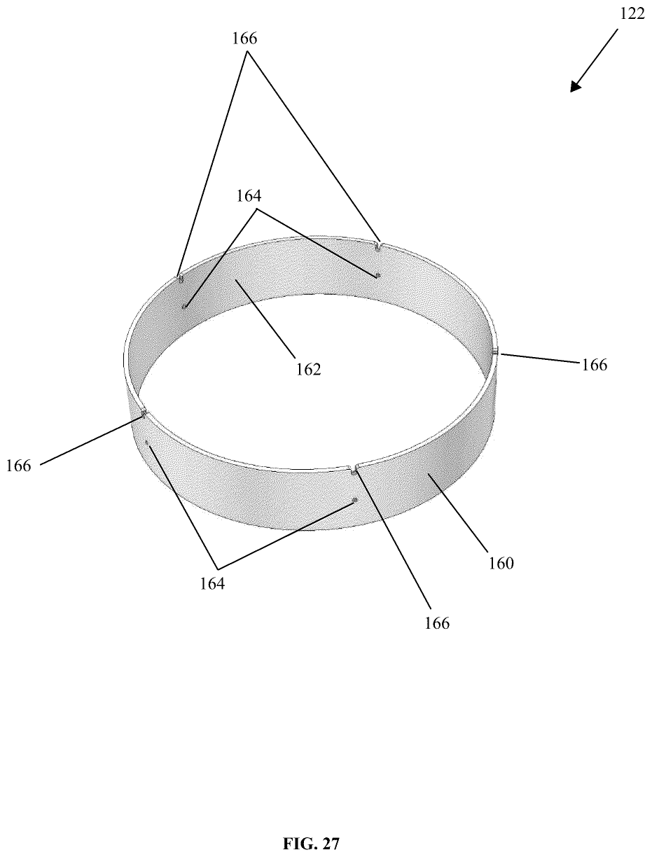

In the illustrative arrangement shown, as one example, system 10 includes inlet system 18. Inlet system 18 is formed of any suitable size, shape, and design and in the illustrative embodiments is configured to allow fuel or other material (e.g., other liquid material such as water, other material that may be fluidized such as powders, granules, etc.) from an outside source to enter main pit 20 of system 10. In the illustrative arrangement shown, as one example, inlet system 18 has an outer end 26 and an inner end 28. In the illustrative arrangement shown, as one example, inlet system 18 includes a conduit 30, a fitting 32 with a seal 34, and gussets 36. In one or more illustrative arrangements shown, as examples, there is one inlet system 18, however in various alternative arrangements, as examples, there may be more than one inlet system 18 such as two inlet systems 18 (as shown at least in the illustrative arrangement in FIG. 22), three inlet systems 18, four inlet systems 18, five inlet systems 18, or any other number of inlet systems 18 as may be required for the location where system 10 is being installed or the desired specifications of system 10 without limitation unless otherwise indicated in the following claims.

Conduit 30: In the illustrative arrangement shown, as one example, inlet system 18 includes conduit 30. Conduit 30 is formed of any suitable size, shape, and design and is configured to connect to an outside pipe, hose, or other material handling component and provide a passage through which fuel or other material can travel in order to enter system 10. In the illustrative arrangement shown, as one example, conduit 30 includes an exterior surface 38, an outer end 40, an inner end 42, a hollow interior 44, and an interior surface 46.

In the illustrative arrangement shown, as one example, conduit 30 is configured as an elongated pipe formed primarily of a high-density polyethylene (HDPE). However, the conduit 30 may be constructed of any suitable material either currently known or later developed, which material suitability may depend at least on the specific application of the system 10. Accordingly, the material of construction of the conduit 30 is in no way limiting to the scope of the present disclosure unless otherwise indicated in the following claims.

In the illustrative arrangement shown, as one example, conduit 30 is formed of a single, unitary member that is formed of a manufacturing process such as machining, extrusion, forming, molding, additive manufacturing, or the like to form a unitary and monolithic member. Alternatively, conduit 30 may be formed of multiple pieces that are connected or assembled to one another through fusing, bonding, welding, friction fitting, or the like. Accordingly, the scope of the present disclosure is not limited to the specific manufacturing process and/or method used to construct the conduit 30 but extends to all known or later-developed manufacturing processes and/or methods without limitation unless otherwise indicated in the following claims.

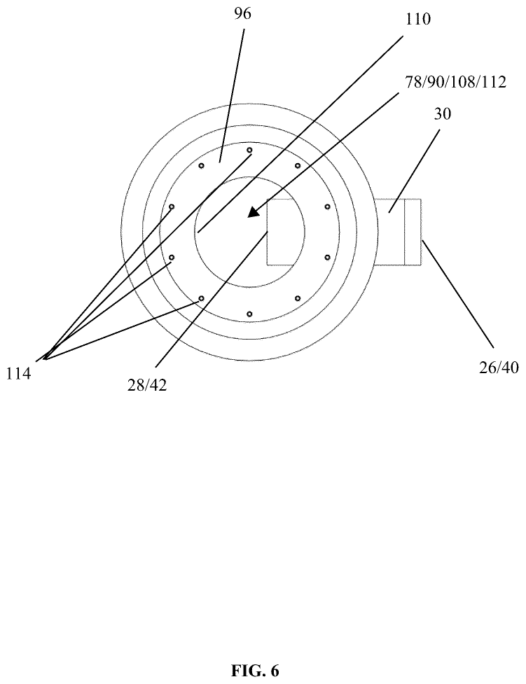

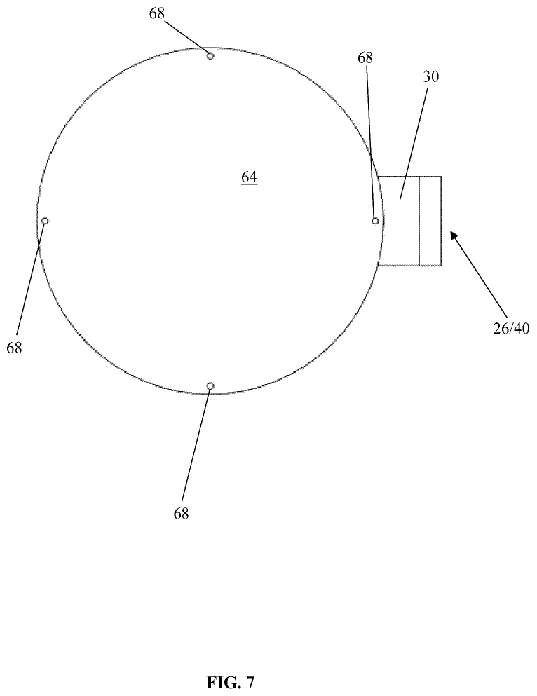

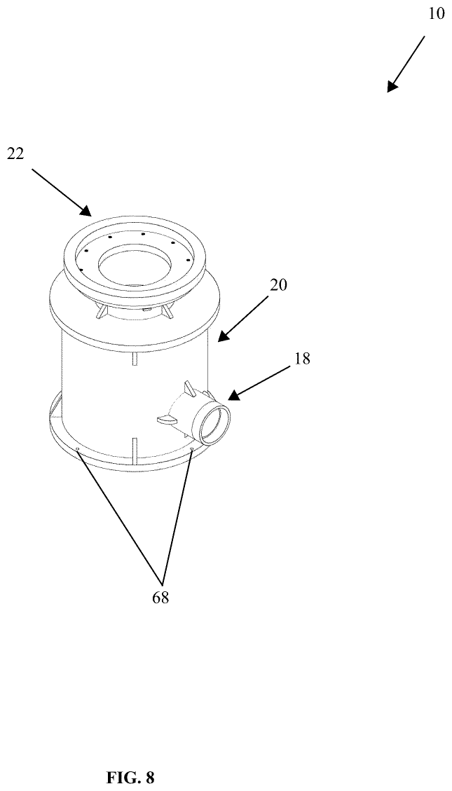

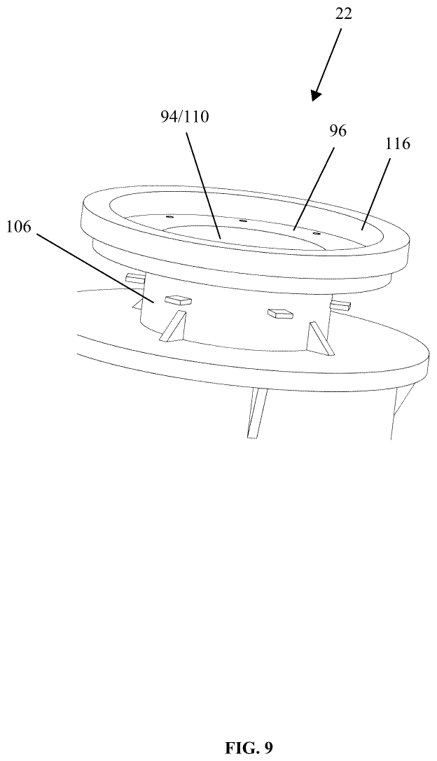

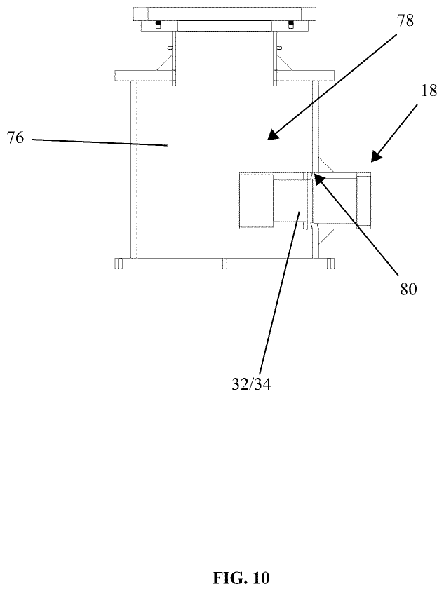

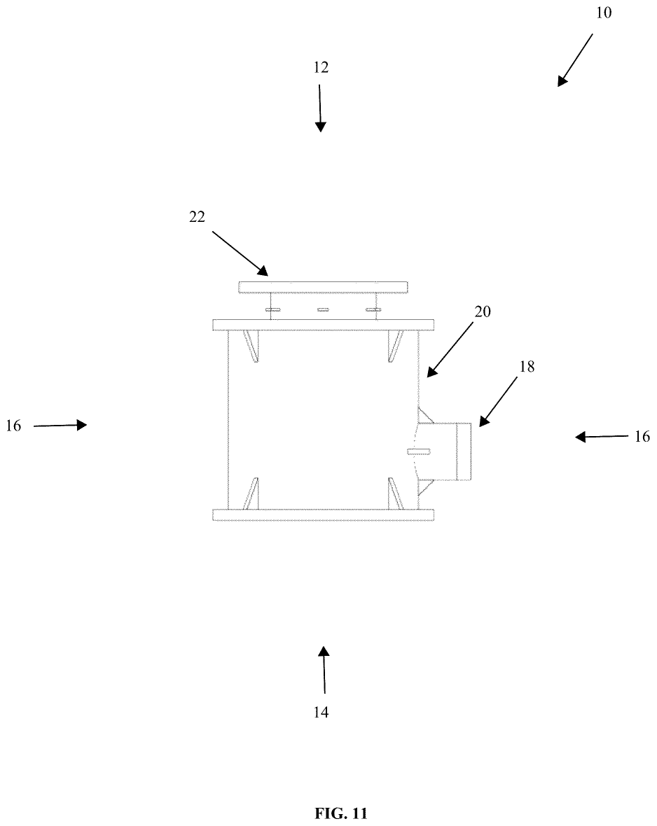

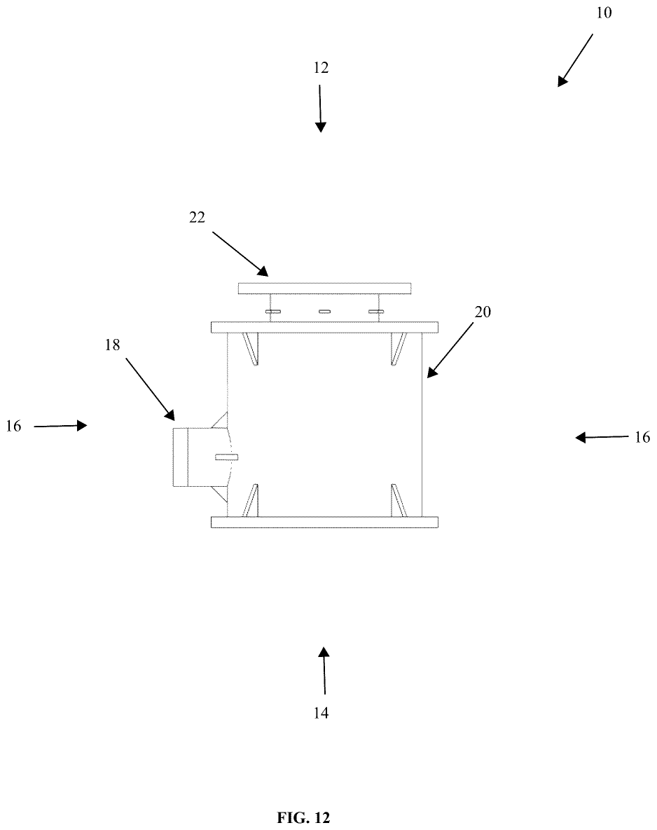

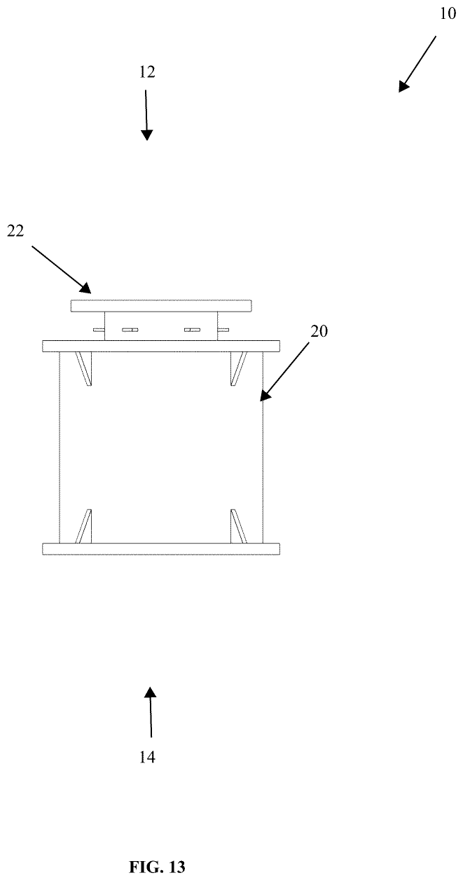

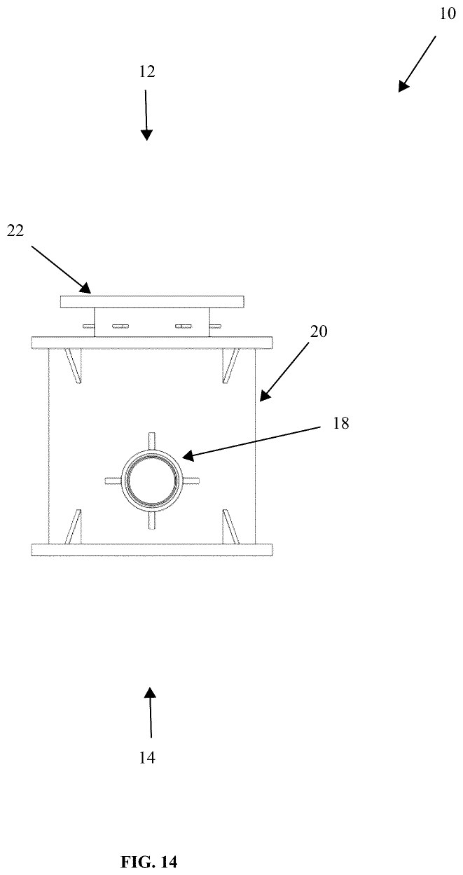

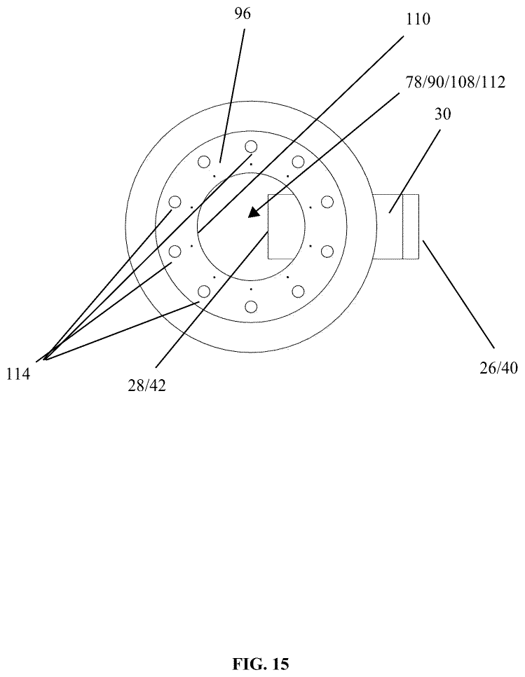

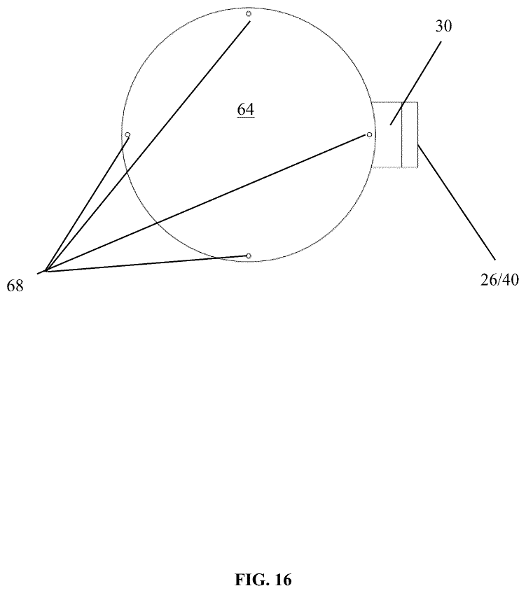

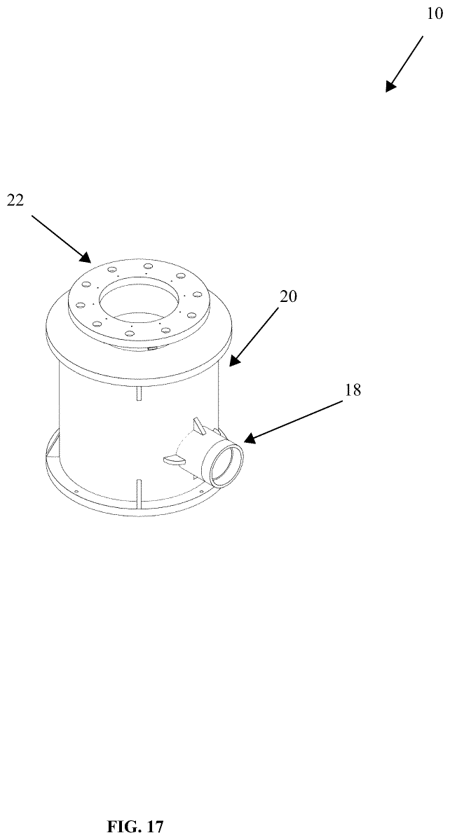

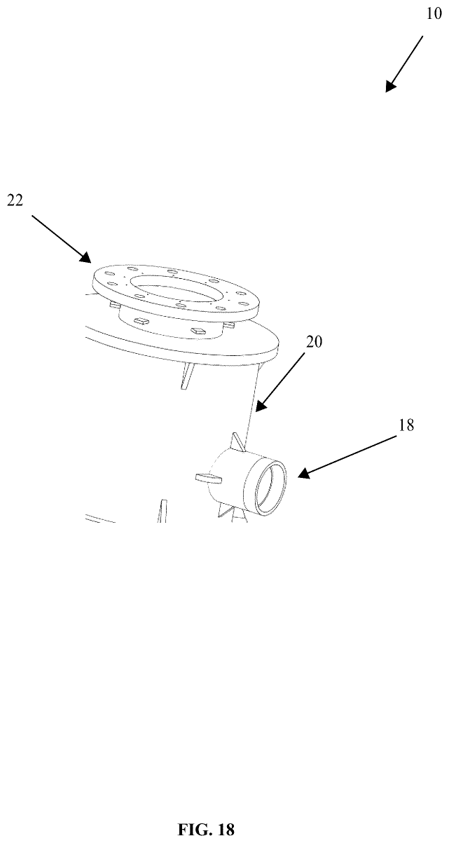

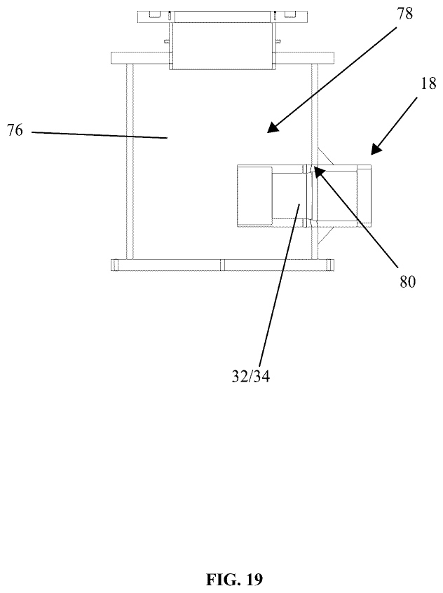

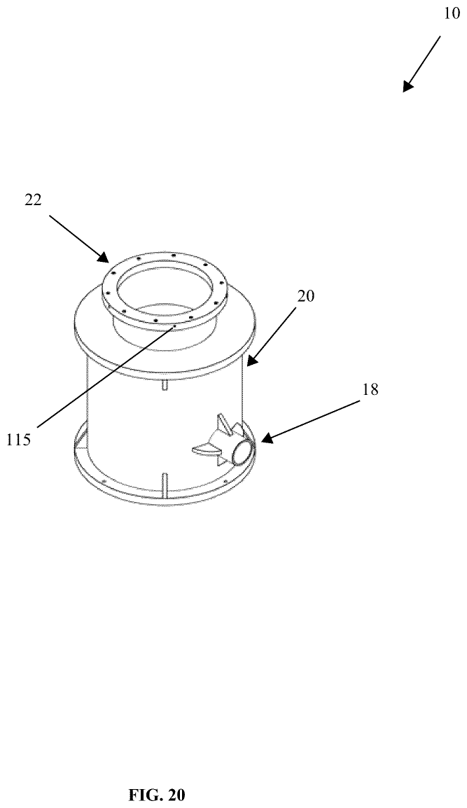

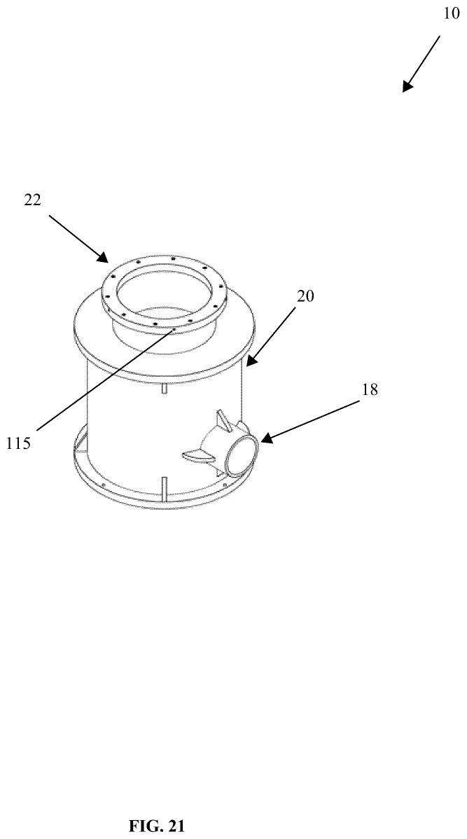

In the illustrative arrangement shown, as one example, when viewed from top end 12 (such as shown at least in FIG. 6, & 15), conduit 30 is elongated and extends between an outer end 40 and an inner end 42. In the illustrative arrangement shown, as one example, when viewed from an opposing side 16, conduit 30 is generally circular in shape, with an outer exterior surface 38, a hollow interior 44, and an interior surface 46. The optimal wall thickness of conduit 30 may vary from one application of system 10 to the next, and for some applications it is contemplated that the optimal thickness will be between 0.1 and 2.0 inches, and more preferably between 0.15 and 1.5 inches, or between 0.1 and 1.0 inches. However, the specific wall thickness of conduit 30 in no way limits the scope of the present disclosure unless otherwise indicated in the following claims.

In the illustrative arrangement shown, as one example, conduit 30 is configured to allow an outside pipe, hose, or other material-handling component to extend through the opening on the outer end 40 and into the hollow interior 44 of conduit 30. In the illustrative arrangement shown, as one example, the hollow interior 44 is in alignment with the opening 80 of body 58 of main pit 20. In this arrangement, the outside pipe, hose, or other material handling component can extend through both the hollow interior 44 of conduit 30 and the opening 80 of body 58 of main pit 20 in to deliver fuel or other material into the main pit 20 of system 10 and/or provide access to the hollow interior 78 of main pit 20 for other components (e.g., cameras, tools, etc.) as may be required without limitation unless otherwise indicated in the following claims. In one or more arrangements, conduit 30 extends at least partially through opening 80 of body 58 such that a portion of conduit 30 rests within the hollow interior 78 of body 58. In the illustrative arrangement shown, as one example, the outside pipe, hose, or other material handling component is connected to conduit 30 within close and tight tolerances by fitting 32 and seal 34 and thereby may create a watertight, environmental, weatherproof, nearly hermetic, hermetic, pressure-tight, and/or otherwise suitable seal.

Fitting 32: In the illustrative arrangement shown, as one example, inlet system 18 includes fitting 32. Fitting 32 is formed of any suitable size, shape, and design and is configured to operably connect an outside pipe or hose to inlet system 18. In the arrangement shown, as one example, fitting 32 is a transition fitting with an HDPE portion and a steel portion. In the arrangement shown, as one example, the HDPE portion of fitting 32 is operably connected to conduit 30 by process of fusion, bonding, or welding. In the arrangement shown, as one example, the steel portion rests inside of conduit 30 and is configured to allow the outside pipe or hose to pass through fitting 32. In this way, fitting 32 operably connects an outside pipe or hose to inlet system 18 in order for the outside pipe or hose to deliver fuel or other material to system 10. In the arrangement shown, as one example, a seal 34 is placed within fitting 32.

Seal 34: In the illustrative arrangement shown, as one example, inlet system 18 includes seal 34. Seal 34 is formed of any suitable size, shape, and design and is configured to provide a watertight, environmental, weatherproof, nearly hermetic, hermetic, pressure-tight, and/or otherwise suitable seal where the outside pipe, hose, or other material handling component is operably connected to inlet system 18. In other words, seal 34 is configured to keep water, air, and other material from entering inlet system 18, and seal 34 is configured to simultaneously prevent fuel or other material from leaking out of inlet system 18.

In the illustrative arrangement shown, as one example, seal 34 is configured as a modular pipe sealing system. More specifically, in the illustrative arrangement shown, as one example, seal 34 may be configured as a LINK-SEAL® Modular Pipe Sealing System. However, other types of seals 34 may be used without departing from the scope of the present disclosure, and the particular brand, configuration, etc. of the seal does not limit the scope of the present disclosure unless otherwise indicated in the following claims.

In the illustrative arrangement shown, as one example, seal 34 is placed within fitting 32 such that it engages the steel portion of fitting 32. In the illustrative arrangement shown, as one example, the outside pipe, hose, or other material handling component is extended through a hollow interior of seal 34. Seal 34 then is manipulated to engage both the steel portion of fitting 32 and the outside pipe, hose, or other material handling component in close and tight tolerances. When seal 34 is held in close and tight tolerances between the steel portion of fitting 32 and the outside pipe, hose, or other material handling component, a watertight, environmental, weatherproof, nearly hermetic, hermetic, pressure-tight, and/or otherwise suitable seal is formed, thereby preventing fuel or other material from leaking out of system 10, and simultaneously preventing water or other material from entering into system 10 through inlet system 18.

Gussets 36: In the illustrative arrangement shown, as one example, inlet system 18 includes a plurality of gussets 36. Gussets 36 is formed of any suitable size, shape, and design and are configured to provide structural support to inlet system 18 and help to operably connect inlet system 18 to main pit 20.

In the illustrative arrangement shown, as one example, gussets 36 are triangular-shaped members. In the illustrative arrangement shown, as one example, gussets 36 are formed primarily of HDPE. However, the gussets 36 may be constructed of any suitable material either currently known or later developed, which material suitability may depend at least on the specific application of the system 10. Accordingly, the material of construction of the gussets 36 is in no way limiting to the scope of the present disclosure unless otherwise indicated in the following claims.

In the illustrative arrangement shown, as one example, four gussets 36 are employed, and are equally spaced around the perimeter of the conduit 30. In various alternative arrangements, as examples, there may be any numbers of gussets 36 including one, two, three, four, five, six, seven, eight, nine, ten, or any other number of gussets 36 without limitation unless otherwise indicated in the following claims. In various alternative arrangements, gussets 36 may be spaced at any location around conduit 30. Accordingly, the specific number, arrangement, spacing, size, configuration, etc. of the gussets 36 in no way limits the scope of the present disclosure unless otherwise indicated in the following claims.

In the illustrative arrangement shown, as one example, gussets 36 are configured to operably connect to the exterior surface 74 of body 58 of main pit 20 and to the exterior surface 38 of conduit 30 of inlet system 18. In this way, gussets 36 serve to operably connect inlet system 18 to main pit 20 and provide support/structural integrity at this connection. The optimal thickness of gussets 36 may vary from one application of system 10 to the next, and for some applications it is contemplated that the optimal thickness will be between 0.1 and 3.0 inches, and more preferably between 0.15 and 2.0 inches. However, the specific thickness of gussets 36 in no way limits the scope of the present disclosure unless otherwise indicated in the following claims. While inlet system 18 and its various components have been described according to the illustrative arrangements shown, as one example, it will be understood by those skilled in the art that any other configurations of inlet system 18 and/or its components may be used to allow fuel or other material from an outside source to enter the main pit 20 of system 10. The optimal configuration of inlet system 18 and/or the components thereof may vary from one application of system 10 to the next and is therefore in no way limiting to the scope of the present disclosure unless otherwise indicated in the following claims.

### Main Pit 20

In the illustrative arrangement shown, as one example, system 10 includes main pit 20. Main pit 20 is formed of any suitable size, shape, and design and is configured to operably connect to the inlet system 18 and outlet system 22 and receive and contain fuel or other material (e.g., other liquid material such as water, other material that may be fluidized such as powders, granules, etc.) therein. In the illustrative arrangement shown, as one example, main pit 20 has a bottom side 50, a top side 52, and opposing left and right sides 54 (or simply “sides 54”). In the illustrative arrangement shown, as one example, main pit 20 includes a bottom plate 56, a body 58, and a top plate 60.

Bottom Plate 56: In the illustrative arrangement shown, as one example, main pit 20 includes a bottom plate 56. Bottom plate 56 is formed of any suitable size, shape, and design and is configured to secure system 10 in place and operably connect to body 58 in order to help contain fuel or other material within main pit 20. In the illustrative arrangement shown, as one example, bottom plate 56 includes a top side 62, a bottom side 64, an exterior surface 66, and one or more holes 68.

In the illustrative arrangement shown, as one example, bottom plate 56 is formed primarily of one or more HDPE sheets. However, the bottom plate 56 may be constructed of any suitable material either currently known or later developed, which material suitability may depend at least on the specific application of the system 10. Accordingly, the material of construction of the bottom plate 56 is in no way limiting to the scope of the present disclosure unless otherwise indicated in the following claims.

In the arrangement shown as one example, bottom plate 56 is formed of a single, unitary member that may be formed in a manufacturing process such as molding, machining, extrusion, forming, molding, additive manufacturing, or the like to form a unitary and monolithic member. Alternatively, bottom plate 56 may be formed of multiple pieces that are connected or assembled to one another through fusing, bonding, welding, friction fitting, or the like. Accordingly, the scope of the present disclosure is not limited to the specific manufacturing process and/or method used to construct the bottom plate 56 but extends to all known or later-developed manufacturing processes and/or methods without limitation unless otherwise indicated in the following claims.

In the illustrative arrangement shown, as one example, bottom plate 56 is configured as a generally flat and circular member. In the illustrative arrangement shown, as one example, when viewed from a side 16 of system 10, top side 62 and bottom side 64 extends in approximate parallel planar spaced relation to one another. In the illustrative arrangement shown, as one example, exterior surface 66 extends around the periphery of bottom plate 56 and intersect top side 62 and bottom side 64 in an approximate perpendicular manner. The optimal thickness of bottom plate 56 may vary from one application of system 10 to the next, and for some applications it is contemplated that the optimal thickness will be between 0.1 and 3.0 inches, and more preferably between 0.15 and 2.0 inches. However, the specific thickness of bottom plate 56 in no way limits the scope of the present disclosure unless otherwise indicated in the following claims.

In the illustrative arrangement, as one example, bottom plate 56 includes one or more holes 68. Holes 68 are formed of any suitable size, shape, and design and are configured to receive and hold a bolt, screw, rod, anchor, and/or combinations thereof or any other kind or type of fastener or securing mechanism therein, without limitation unless otherwise indicated in the following claims, in order to secure system 10 in place. In the illustrative arrangement shown, as one example, holes 68 extends through bottom plate 56 from top side 62 to and through bottom side 64. In the illustrative arrangement shown, as one example, five holes 68 are formed in bottom plate 56 generally equally spaced from one another, however any other number of holes 68 may be present in bottom plate 56 including one, two, three, four, six, seven, eight, nine, ten, or any other number of holes 68. Additionally, holes 68 may be any shape or size and holes 68 may be spaced relatively to other holes 68 in any desired manner or arrangement. Accordingly, the specific number, spacing, size, arrangement, and/or configuration of holes 68 may vary from one embodiment of the bottom plate 56 to the next and are in no way limiting to the scope of the present disclosure unless otherwise indicated in the following claims.

In the illustrative arrangement shown, as one example, the top side 62 of bottom plate 56 and operably connect to the bottom end 72 of body 58 of main pit 20.

Body 58: In the illustrative arrangement shown, as one example, main pit 20 includes body 58. Body 58 is formed of any suitable size, shape, and design. Body 58 is configured to operably connect to bottom plate 56 and top plate 60 and receive and contain fuel or other material therein. In the illustrative arrangement shown, as one example, body 58 includes a top end 70, a bottom end 72, an exterior surface 74, an interior surface 76, a hollow interior 78, an opening 80, and gussets 82. The optimal thickness of body 58 (i.e., the distance from exterior surface 74 to interior surface 76) may vary from one application of system 10 to the next, and for some applications it is contemplated that the optimal thickness will be between 0.1 and 3.0 inches, and more preferably between 0.20 and 2.0 inches, or between 0.20 and 1.8 inches. However, the specific thickness of body 58 in no way limits the scope of the present disclosure unless otherwise indicated in the following claims.

In the illustrative arrangement shown, as one example, body 58 is configured as an elongated pipe formed primarily of HDPE. However, body 58 may be constructed of any suitable material either currently known or later developed, which material suitability may depend at least on the specific application of the system 10. Accordingly, the material of construction of body 56 is in no way limiting to the scope of the present disclosure unless otherwise indicated in the following claims.

In one or more arrangements, as examples, body 58 is configured as a 48-inch diameter pipe. In one or more alternative arrangements, as examples, body 58 is configured as a 60-inch diameter pipe. In further alternative arrangements, as examples, body 58 may be any other diameter pipe. In other alternative arrangements, body 58 may be differently sized and/or shaped without limitation unless otherwise indicated in the following claims.

In the arrangement shown, as one example, body 58 is formed of a single unitary member that is formed of a manufacturing process such as machining, extrusion, forming, molding, additive manufacturing, or the like to form a unitary and monolithic member. Alternatively, body 58 may be formed of multiple pieces that are connected or assembled to one another through fusing, bonding, welding, friction fitting, or the like. Accordingly, the scope of the present disclosure is not limited to the specific manufacturing process and/or method used to construct body 58 but extends to all known or later-developed manufacturing processes and/or methods without limitation unless otherwise indicated in the following claims.

In the illustrative arrangement shown, as one example, when viewed from a side 16 of system 10, body 58 is elongated and extends to a height between top end 70 and bottom end 72. In the illustrative arrangement shown, as one example, when viewed from top end 12 of system 10, body 58 is generally circular in shape, with an exterior surface 74, an interior surface 76, and a hollow interior 78.

In the illustrative arrangement shown, as one example, body 58 includes an opening 80. Opening 80 is formed of any suitable size, shape, and design and configured to align with the hollow interior 44 of conduit 30 and allow fuel or other material to enter into the hollow interior 78 of body 58 of main pit 20. In the illustrative arrangement shown, as one example, opening 80 is similarly sized and shaped to the hollow interior 44 of conduit 30 such that hollow interior 44 and opening 80 of body 58 form one aperture that allows an outside pipe, hose, or other material handling component to pass through conduit 30 and the exterior surface 74 of body 58 and into the hollow interior 78 of body 58.

In the illustrative arrangement shown, as one example, the outside pipe, hose, or other material handling component is configured to transport fuel or other material into the hollow interior 78 of body 58, where it is then housed until needed. In the illustrative arrangement shown, as one example, the HDPE material of body 58 is fuel resistant, and in other illustrative arrangements the material of body 58 is impervious to the specific material for which the body 58 is designed. In the illustrative arrangement shown, as one example, body 58 is operably connected to each of conduit 30, bottom plate 56, and top plate 60 such that no fuel or other material will leak out of system 10 and no liquid or other material from outside of system 10 will enter into system 10. In the illustrative arrangement shown, as one example, body 58 is connected to each of conduit 30, bottom plate 56, and top plate 60 using any method of connection including fusion, bonding, welding, combinations thereof, and/or any other suitable method without limitation unless otherwise indicated in the following claims.

In the illustrative arrangement shown, as one example, body 58 includes one or more gussets 82. Gussets 82 are formed of any suitable size, shape, and design and are configured to provide structural support to main pit 20 and help to operably connect body 58 to both bottom plate 56 and top plate 60.

In the illustrative arrangement shown, as one example, gussets 82 are triangular-shaped members. In the illustrative arrangement shown, as one example, gussets 82 are formed primarily of HDPE. However, gussets 82 may be constructed of any suitable material either currently known or later developed, which material suitability may depend at least on the specific application of the system 10. Accordingly, the material of construction of gussets 36 is in no way limiting to the scope of the present disclosure unless otherwise indicated in the following claims.

In the illustrative arrangement shown, as one example, four gussets 82 are employed, and are generally equally spaced around body 58 near the top end 70 of body 58, and four gussets 82 are generally equally spaced around body 58 near the bottom end 72 of body 58. In various alternative arrangements, as examples, there may be any number of gussets 82 near each of the top end 70 and bottom end 72 including one, two, three, four, five, six seven, eight, nine, ten, or any other number of gussets 82 at each of the top end 70 and bottom end 72 of body 58. Additionally, gussets 82 may be any shape or size and may be spaced relatively to other gussets 82 in any desired manner or arrangement. Accordingly, the specific number, spacing, size, arrangement, and/or configuration of gussets 82 may vary from one embodiment of system to the next and are in no way limiting to the scope of the present disclosure unless otherwise indicated in the following claims.

In the illustrative arrangement shown, as one example, the gussets 82 positioned near the bottom end 72 of body 58 are configured to operably connect to the exterior surface 74 of body 58 and to the top side 62 of bottom plate 56. In this way, gussets 82 help to operably connect body 58 to bottom plate 56 and provide structural support at this connection.

In the illustrative arrangement shown, as one example, gussets 82 positioned near the top end 70 of body 58 are configured to operably connect to the exterior surface 74 of body 58 and to the bottom side 84 of top plate 60. In this way, gussets 82 serve to operably connect body 58 to top plate 60 and provide structural support at this connection.

Top Plate 60: In the illustrative arrangement shown, as one example, main pit 20 includes top plate 60. Top plate 60 is formed of any suitable size, shape, and design and is configured to operably connect main pit 20 to outlet system 22 and to help support and house valves, hoses, other tooling, and/or other components necessary to transfer fuel or other material out of the system 10 when desired. In the illustrative arrangement shown, as one example, top plate 60 includes a bottom side 84, top side 86, an exterior surface 88, and an opening 90. The optimal thickness of top plate 60 may vary from one application of system 10 to the next, and for some applications it is contemplated that the optimal thickness will be between 0.1 and 3.0 inches, and more preferably between 0.15 and 2.0 inches. However, the specific thickness of top plate 60 in no way limits the scope of the present disclosure unless otherwise indicated in the following claims.

In the illustrative arrangement shown, as one example, top plate 60 is formed primarily of one or more HDPE sheets. However, top plate 60 may be constructed of any suitable material either currently known or later developed, which material suitability may depend at least on the specific application of the system 10. Accordingly, the material of construction of top plate 60 is in no way limiting to the scope of the present disclosure unless otherwise indicated in the following claims.

In the illustrative arrangement shown as one example, top plate 60 is formed of a single, unitary member that may be formed in a manufacturing process such as molding, machining, extrusion, forming, molding, additive manufacturing, or the like to form a unitary and monolithic member. Alternatively, top plate 60 may be formed of multiple pieces that are connected or assembled to one another through fusing, bonding, welding, friction fitting, or the like.

Accordingly, the scope of the present disclosure is not limited to the specific manufacturing process and/or method used to construct top plate 60 but extends to all known or later-developed manufacturing processes and/or methods without limitation unless otherwise indicated in the following claims.

In the illustrative arrangement shown, as one example, top plate 60 is configured as a generally flat and circular member. In the illustrative arrangement shown, as one example, when viewed from a side 16 of system 10, bottom side 84 and top side 86 extend in approximate parallel planar spaced relation to one another. In the illustrative arrangement shown, as one example, exterior surface 88 extends around the periphery of top plate 60 and intersect bottom side 84 and top side 86 in an approximate perpendicular manner.

In the illustrative arrangement shown, as one example, top plate 60 includes an opening 90. Opening 90 is formed of any suitable size, shape, and design and is configured to allow valves, hoses, other tooling, and/or other components necessary to transfer fuel or other material out of the system 10 to be inserted into system 10 and reach the fuel or other material contained within the main pit 20 of system 10. In the illustrative arrangement shown, as one example, opening 90 extends through top plate 60 from bottom side 84 to and through top side 86. In the illustrative arrangement shown, as one example, opening 90 is sized and shaped to align with the hollow interior 108 of conduit 94 of outlet system 22.

In the illustrative arrangement shown, as one example, the top side 86 of top plate 60 operably connects to the lower end 102 of conduit 94 of outlet system 22.

While main pit 20 and its components have been described according the illustrative arrangement shown, as one example, it will be understood by those skilled in the art that any other configuration of main pit 20 and its components may be used in order to operably connect to the inlet system 18 and outlet system 22, and receive and contain fuel or other material therein. The optimal configuration of main pit 20 and/or the components thereof may vary from one application of system 10 to the next and is therefore in no way limiting to the scope of the present disclosure unless otherwise indicated in the following claims.

### Outlet System 22

In the illustrative arrangement shown, as one example, system 10 includes outlet system 22. Outlet system 22 is formed of any suitable size, shape, and design and is configured to operably connect main pit 20 and allow fuel or other material (e.g., other liquid material such as water, other material that may be fluidized such as powders, granules, etc.) to be transported out of system 10 when desired. In the illustrative arrangement shown, as one example, outlet system 22 includes a conduit 94, a flange 96, gussets 98, and tabs 100. In the illustrative arrangement shown, as one example, outlet system 22 also includes a manhole cover 120 (or simply “cover 120”) and a ring 122.

Conduit 94: In the illustrative arrangement shown, as one example, outlet system 22 includes conduit 94. Conduit 94 is formed of any suitable size, shape, and design and is configured to allow valves, hoses, other tooling, and/or other components necessary to extend wholly or partially therethrough in order for fuel or other material to be transferred out of main pit 20. In the illustrative arrangement shown, as one example, conduit 94 has a lower end 102, an upper end 104, an exterior surface 106, a hollow interior 108, and an interior surface 110. The optimal thickness of conduit 94 (i.e., the distance between interior surface 110 and exterior surface 106) may vary from one application of system 10 to the next, and for some applications it is contemplated that the optimal thickness will be between 0.1 and 3.0 inches, and more preferably between 0.15 and 1.5 inches. However, the specific thickness of conduit 94 in no way limits the scope of the present disclosure unless otherwise indicated in the following claims.

In the illustrative arrangement shown, as one example, conduit 94 is an elongated pipe formed primarily of HDPE. However, the conduit 94 may be constructed of any suitable material either currently known or later developed, which material suitability may depend at least on the specific application of the system 10. Accordingly, the material of construction of the conduit 94 is in no way limiting to the scope of the present disclosure unless otherwise indicated in the following claims.

In the illustrative arrangement shown, as one example, conduit 94 is formed of a single, unitary member that may be formed of a manufacturing process such as machining, extrusion, forming, molding, additive manufacturing, or the like to form a unitary and monolithic member. Alternatively, conduit 94 may be formed of multiple pieces that are connected or assembled to one another through fusing, bonding, welding, friction fitting, or the like. Accordingly, the scope of the present disclosure is not limited to the specific manufacturing process and/or method used to construct the conduit 94 but extends to all known or later-developed manufacturing processes and/or methods without limitation unless otherwise indicated in the following claims.

In the illustrative arrangement shown, as one example, when viewed from a side 16 of system 10, conduit 94 is elongated and extends between a lower end 102 and an upper end 104. In the illustrative arrangement shown, as one example, when viewed from top end 12 of system 10, conduit 94 is generally circular in shape, with an exterior surface 106, a hollow interior 108, and an interior surface 110.

In the illustrative arrangement shown, as one example, conduit 94 is configured to allow valves, hoses, other tooling, and/or other components necessary to extend wholly or partially through the opening at both the lower end 102 and upper end 104, and through the hollow interior 108 of conduit 94, in order for the valves, hoses, other tooling, and/or other components necessary to reach the fuel or other material contained in main pit 20, extract that fuel or other material, and transport it out of system 10. In the illustrative arrangement shown, as one example, the hollow interior 108 of conduit 94 is in alignment with the opening 90 of top plate 60. In this illustrative arrangement, as one example, the valves, hoses, other tooling, and/or other components necessary can extend through both the hollow interior 108 of conduit 94 and opening 90 of top plate 60 to reach the fuel or other material contained in main pit 20.

In the illustrative arrangement shown, as one example, the valves, hoses, other tooling, and/or other components necessary extending partially or wholly through conduit 94 extends out of the opening at the upper end 104 of conduit 94, past flange 96 of outlet system 22, and out of system 10 altogether.

Flange 96: In the illustrative arrangement shown, as one example, outlet system 22 includes flange 96. Flange 96 is formed of any suitable size, shape, and design and is configured to facilitate connection between outlet system 22 and manhole cover 120 for system 10. In the illustrative arrangement shown, as one example, flange 96 is a generally circular member that connects to the upper end 104 of conduit 94 and extends a distance outward from the exterior surface 106 of conduit 94. In the illustrative arrangement shown, as one example, flange 96 has an opening 112, holes 114, and apertures 115. The optimal thickness of flange 96 may vary from one application of system 10 to the next, and for some applications it is contemplated that the optimal thickness will be between 0.1 and 3.0 inches, and more preferably between 0.15 and 1.5 inches. However, the specific thickness of flange 96 in no way limits the scope of the present disclosure unless otherwise indicated in the following claims.

In the illustrative arrangement shown, as one example, flange 96 is formed primarily of one or more HDPE sheets. However, flange 96 may be constructed of any suitable material either currently known or later developed, which material suitability may depend at least on the specific application of the system 10. Accordingly, the material of construction of flange 96 is in no way limiting to the scope of the present disclosure unless otherwise indicated in the following claims.

In the illustrative arrangement shown as one example, flange 96 is formed of a single, unitary member that may be formed in a manufacturing process such as molding, machining, extrusion, forming, molding, additive manufacturing, or the like to form a unitary and monolithic member. Alternatively, flange 96 may be formed of multiple pieces that are connected or assembled to one another through fusing, bonding, welding, friction fitting, or the like. Accordingly, the scope of the present disclosure is not limited to the specific manufacturing process and/or method used to construct flange 96 but extends to all known or later-developed manufacturing processes and/or methods without limitation unless otherwise indicated in the following claims.

Opening 112 of flange 96 is configured to align with the hollow interior 108 of conduit 94 for valves, hoses, other tooling, and/or other components necessary can extend through the opening 112 of flange 96. Holes 114 of flange 96 are configured to allow fasteners, bolts, rods, or any other type of connection member to extend therethrough in order to attach cover 120 to outlet system 22. Apertures 115 of flange 96 are configured to allow fasteners, bolts, rods, or any other type of connection member to extend therethrough in order to attach ring 122 to outlet system 22.

In one or more illustrative arrangements, as examples, the flange 96 may include an additional raised peripheral edge 116. Raised peripheral edge 116 is formed of any suitable size, shape, and design and is configured to house at least a portion of cover 120 to outlet system 22 within the raised peripheral edge 116. In the illustrative arrangement shown, as one example, the raised peripheral edge extends upward a distance around the periphery of flange 96. In various alternative arrangements, shown as examples, flange 96 does not contain a raised peripheral edge.

Gussets 98: In the illustrative arrangement shown, as one example, outlet system 22 includes gussets 98. Gussets 98 are formed of any suitable size, shape, and design and are configured to provide structural support to outlet system 22 and help to operably connect outlet system 22 to main pit 20. The optimal thickness of gussets 98 may vary from one application of system 10 to the next, and for some applications it is contemplated that the optimal thickness will be between 0.1 and 3.0 inches, and more preferably between 0.15 and 1.5 inches. However, the specific thickness of gussets 98 in no way limits the scope of the present disclosure unless otherwise indicated in the following claims.

In the illustrative arrangement shown, as one example, gussets 98 are triangular shaped members. In the illustrative arrangement shown, as one example, gussets 98 are formed primarily of HDPE. However, gussets 98 may be constructed of any suitable material either currently known or later developed, which material suitability may depend at least on the specific application of system 10. Accordingly, the material of construction of gussets 98 is in no way limiting to the scope of the present disclosure unless otherwise indicated in the following claims.

In the illustrative arrangement shown, as one example, there are four gussets 98 that are equally spaced around conduit 94 of outlet system 22. In various alternative illustrative arrangements, as examples, there may be any number of gussets 98 including one, two, three, four, five, six, seven, eight, nine, ten, or any other number of gussets 98. In various alternative arrangements, gussets 98 may be spaced at any locations around conduit 94 of outlet system 22. Additionally, gussets 98 may be any shape or size and may be spaced relatively to other gussets 98 in any desired manner or arrangement. Accordingly, the specific number, spacing, size, arrangement, and/or configuration of gussets 98 may vary from one embodiment of outlet system 22 to the next and are in no way limiting to the scope of the present disclosure unless otherwise indicated in the following claims.

In the illustrative arrangement shown, as one example, gussets 98 operably connect to the exterior surface 106 of conduit 94 of outlet system 22 and to the top side 86 of top plate 60 of main pit 20. In this way, gussets 98 help to operably connect outlet system 22 to main pit 20 and provide support/structural integrity at this connection.

Tabs 100: In the illustrative arrangement shown, as one example, outlet system 22 includes tabs 100. Tabs 100 are formed of any suitable size, shape, and design and are configured to transfer a load that may be present on the top of outlet system 22 to the concrete and/or other material surrounding system 10.

In the illustrative arrangement shown, as one example, tabs 100 are square or rectangular shaped members. In the illustrative arrangement shown, as one example, tabs 100 are formed primarily of HDPE. However, tabs 100 may be constructed of any suitable material either currently known or later developed, which material suitability may depend at least on the specific application of the system 10. Accordingly, the material of construction of tabs 100 is in no way limiting to the scope of the present disclosure unless otherwise indicated in the following claims.

In the illustrative arrangement shown, as one example, there are six tabs 100 that are equally spaced around conduit 94 of outlet system 22. In various alternative arrangements, as examples, there may be any number of tabs 100 including one, two, three, four, five, six, seven, eight, nine, ten, or any other number of tabs 100. Additionally, tabs 100 may be any shape or size and may be spaced relatively to other tabs 100 in any desired manner or arrangement. Accordingly, the specific number, spacing, size, arrangement, and/or configuration of tabs 100 may vary from one embodiment of system 10 to the next and are in no way limiting to the scope of the present disclosure unless otherwise indicated in the following claims.

In one or more illustrative arrangements, system 10 may be used at airports. Specifically, system 10 can be positioned such that system 10 is primarily located under a runway, taxiway, and/or apron (or ramp) at an airport and only a portion of the outlet system 22 of system 10 extends upward relative to the surface of the runway, taxiway, and/or apron at the airport (e.g., a manhole cover 120 in some illustrative arrangements as described in further detail below). In such cases, a plane may travel over such portion of the outlet system 22 without disruption to the plane. That is, the system 10 may be configured such that the portion of the outlet system 22 above the surface of the runway, taxiway, and/or apron is nominal and is easily traversed by the plane even if a wheel of the plane travels directly over that portion of the outlet system 22 and causes negligible movement to the cabin of the plane. In such cases, tabs 100 function to transfer the load of the plane from outlet system 22 and system 10 to the concrete and/or other material surrounding system 10, thereby reducing the load on system 10 and preventing outlet system 22 from deforming or failing under such load. The specific configuration of tabs 100 (e.g., number, size, spacing, position, etc.) may affect the size of load for which a specific system 10 is designed, and it is contemplated that the optimal configuration of the tabs 100 will vary from one application of system 10 to the next, and is therefore in no way limiting to the scope of the present disclosure unless otherwise indicated in the following claims.

Manhole Cover 120: In the illustrative arrangement shown, as one example, outlet system 22 includes a manhole cover 120 (or simply “cover 120”). Cover 120 is formed of any suitable size, shape, and design and is configured to connect to flange 96 and allow operators access into the main pit 20 of system 10 to pump fuel, remove other material out of system 10, and/or otherwise perform cleaning, maintenance, or repairs on system 10. In the illustrative arrangement shown, as one example, manhole cover 120 includes a base member 124 with openings 126 and engagement members 128, a hinge 130, and a movable member 132.

In the illustrative arrangement shown, as one example, cover 120 is formed primarily of metallic material. However, cover 120 may be constructed of any suitable material either currently known or later developed, which material suitability may depend at least on the specific application of the system 10. Accordingly, the material of construction of cover 120 and/or components thereof is in no way limiting to the scope of the present disclosure unless otherwise indicated in the following claims.

In the illustrative arrangement shown, as one example, cover 120 is formed of multiple pieces that are connected or assembled to one another through screwing, bolting, friction fitting, or any other method of connection including welding. Alternatively, cover 120 may be formed of a single unitary member that is formed of a manufacturing process such as machining, casting, additive manufacturing, or the like to form a unitary and monolithic member. Accordingly, the scope of the present disclosure is not limited to the specific manufacturing process and/or method used to construct cover 120 but extends to all known or later-developed manufacturing processes and/or methods without limitation unless otherwise indicated in the following claims.

In the illustrative arrangement shown, as one example, cover 120 includes base member 124. Base member 124 is formed of any suitable size, shape, and design and is configured to connect cover 120 to flange 96. In the illustrative arrangement shown, as one example, base member 124 is a generally cylindrical member with an exterior surface 138, an upper surface 140, a lower surface 142, and a hollow interior (not pictured). In the illustrative arrangement shown, as one example, base member 124 includes openings 126 and engagement members 128.

In the illustrative arrangement shown, as one example, engagement members 128 extend outward from the lower surface 142 of base member 124 and are configured to fit within openings 112 in flange 96, thereby facilitating engagement between cover 120 and flange 96. In the illustrative arrangement shown, as one example, openings 126 extend through base member 124 from the upper surface 140 through the bottom of the engagement members 128, thereby allowing a screw, bolt, or other fastener to be placed through the openings 126 of base member 124 and into the openings 112 of flange 96 to place base member 124 and flange 96 in secured engagement with one another. However, other illustrative arrangements may use other components and/or methods to properly engage base member 124 and flange without limitation unless otherwise indicated in the following claims.

In the illustrative arrangement shown, as one example, base member 124 also includes a groove 144 in lower surface 142. In the illustrative arrangement shown, as one example, groove 144 is configured to house and hold a sealing member 146 therein. Sealing member 146 is formed of any suitable size, shape, and design and is configured to provide a watertight, environmental, weatherproof, nearly hermetic, hermetic, pressure-tight, and/or otherwise suitable seal between base member 124 and flange 96 when cover 120 is placed on outlet system 22. In the illustrative arrangement shown, as one example, sealing member 146 is an O-ring formed of HDPE. However, sealing member 146 may be constructed of any suitable material either currently known or later developed, which material suitability may depend at least on the specific application of system 10. Accordingly, the material of construction of sealing member 146 is in no way limiting to the scope of the present disclosure unless otherwise indicated in the following claims.

In the illustrative arrangement shown, as one example, cover 120 includes a hinge 130. Hinge 130 is formed of any suitable size, shape, and design and is configured to operably connect base member 124 and moveable member 132 while still allowing movable member 132 to move between an open position and a closed position. In the illustrative arrangement shown, as one example, hinge 130 may be any type of hinge including a butt hinge, a spring-loaded hinge, a concealed hinge, an overlay hinge, a strap hinge, a gate hinge, a ball bearing hinge, a knuckle hinge, or any other type or configuration of hinge. In the illustrative arrangement shown, as one example, hinge 130 operates to allow movable member 132 to move between a closed position and an open position, wherein the movable member 132 may be configured to lay-flat against the ground at least in a closed position.

In the illustrative arrangement shown, as one example, cover 120 includes a movable member 132. Movable member 132 is formed of any suitable size, shape, and design and is configured to move between an open position and a closed position. In the illustrative arrangement shown, as one example, movable member 132 includes an outer surface 148, a peripheral edge 150 with a groove 152, and an inner surface 154. In the illustrative arrangement shown, as one example, movable member 132 includes a handle 156, which allows an operator to easily grasp movable member 132 and move it between a closed position and an open position.

In the illustrative arrangement shown, as one example, when in the closed position, movable member 132 is operably engaged with base member 124 such that cover 120 closes the opening into system 10. In the illustrative arrangement shown, as one example, when in the open position, movable member 132 may be extending straight upward from base member 124 into the air, or movable member 132 may be configured to open such that the outer surface 148 of movable member 132 lays flat against the ground around system 10 in order to allow more room for operators to operate system 10. That is, movable member 132 and base member 124 may be configured such that movable member 132 may be rotationally engaged with base member 124 at a relative angle therebetween anywhere from zero to 180 degrees.

In the illustrative arrangement shown, as one example, the outer surface 148 of movable member 132 includes groove 152. In the illustrative arrangement shown, as one example, groove 152 is configured to house and hold a sealing member 158 therein. Sealing member 158 is formed of any suitable size, shape, and design and is configured to provide a watertight, environmental, weatherproof, nearly hermetic, hermetic, pressure-tight, and/or otherwise suitable seal between base member 124 and movable member 132 when movable member 132 is in a closed position. In the illustrative arrangement shown, as one example, sealing member 158 is an O-ring formed of HDPE. However, sealing member 158 may be constructed of any suitable material either currently known or later developed, which material suitability may depend at least on the specific application of the system 10. Accordingly, the material of construction of sealing member 158 is in no way limiting to the scope of the present disclosure unless otherwise indicated in the following claims.

In the illustrative arrangement shown, as one example, cover 120 connects to flange 96 by placing the engagement members 128 of base member 124 through the holes 114 of flange 96, then a screw, bolt, or other type of fastener or connection member is placed through the openings 126 of base member 124 and through the holes 114 of flange 96, thereby securing cover 120 to flange 96.

In the illustrative arrangement shown, as one example, operators may wish to install cover 120 at a certain orientation with respect to flange 96. More specifically, operators typically prefer the movable member 132 of cover 120 to open away from the airplane so that movable member 132 is out of the way of the hose, tooling, and/or other material handling component being used in connection with system 10. However, this is not always the case and flexibility is desirable. In order to provide for this, in the illustrative arrangement shown, as one example, there are ten holes 114 in flange 96 and there are five engagement members 128 of base member 124. However, any other number of holes 114 in flange 96 and engagement members 128 of base member 124 may be present. In the illustrative arrangement shown, as one example, with more holes 114 in flange 96 than there are engagement members 128 of base member 124, base member 124 may be oriented in any direction relative to flange 96. That is, base member 124 may be oriented such that the movable member 132 of cover 120 opens, for example, east, west, north, south, or any other direction (whether or not a cardinal direction), no matter how flange 96 is positioned. Other numbers and/or arrangements of engagement members 128 and/or holes 114 may be used to provide additional adjustability between the relative rotational positions of cover 120 and flange 96 in alternative arrangements without limitation unless otherwise indicated in the following claims. This allows operators to have greater control over the environment and system 10 when moving hoses, tooling, and/or other material handling components into and out of system 10 in order to add material (e.g., fuel, water, etc.) to or remove material from system 10.

Once cover 120 is oriented correctly and secured to flange 96, ring 122 may be installed around the periphery of flange 96 and cover 120.

Ring 122: In the illustrative arrangement shown, as one example, outlet system 22 includes ring 122. Ring 122 is formed of any suitable size, shape, and design and is configured to protect the top of outlet system 22, including cover 120, from outside forces such as snowplows and/or other machinery. In the illustrative arrangement shown, as one example, ring 122 has an exterior surface 160, an interior surface 162, holes 164, and slots 166. The optimal thickness of ring 122 may vary from one application of system 10 to the next, and for some applications it is contemplated that the optimal thickness will be between 0.1 and 3.0 inches, and more preferably between 0.15 and 1.0 inches. However, the specific thickness of ring 122 in no way limits the scope of the present disclosure unless otherwise indicated in the following claims.

In the illustrative arrangement shown, as one example, ring 122 is a generally cylindrical member with a hollow interior and ring 122 is primarily made of metallic material. However, ring 122 may be constructed of any suitable material either currently known or later developed, which material suitability may depend at least on the specific application of the system 10. Accordingly, the material of construction of ring 122 is in no way limiting to the scope of the present disclosure unless otherwise indicated in the following claims.

In the arrangement shown, as one example, ring 122 is formed of a single, unitary member that is formed of a manufacturing process such as machining, extrusion, casting, rolling, forming, molding, additive manufacturing, or the like to form a unitary and monolithic member. Alternatively, ring 122 may be formed of multiple pieces that are connected or assembled to one another through welding, adhesion, bolting, screwing, fastening, or the like or any other means of connection. Accordingly, the scope of the present disclosure is not limited to the specific manufacturing process and/or method used to construct ring 122 but extends to all known or later-developed manufacturing processes and/or methods without limitation unless otherwise indicated in the following claims.

In the illustrative arrangement shown, as one example, ring 122 includes holes 164. In the illustrative arrangement shown, as one example, holes 164 extend through ring 122 from the exterior surface 160 to the interior surface 162. In the illustrative arrangement shown, as one example, fasteners, bolts, rods, or any other type of connection member may be placed through holes 164 in ring 122 and through apertures 115 of flange 96, thereby operably connecting ring 122 to flange 96.

In the illustrative arrangement shown, as one example, ring 122 includes slots 166. Slots 166 are formed of any suitable size, shape, and design and are configured to allow water to run off and out from the interior of ring 122. Depending on the weather, ring 122 may be positioned such that slots 166 are oriented upward or downward. In the illustrative arrangement shown, as one example, ring 122 is shaped and sized, and holes 164 are positioned, such that when ring 122 is connected to flange 96, if the slots 166 are positioned upward, ring 122 extends slightly above the top point of movable member 132. In the illustrative arrangement shown, as one example, ring 122 is shaped and sized, and holes 164 are positioned, such that when ring 122 is connected to flange 96, if the slots 166 are positioned downward, ring 122 is essentially flush with the adjacent edge of movable member 132 of cover 120.

In the illustrative arrangement shown, as one example, the movable member 132 of cover 120 slopes downward as it extends from the middle of movable member 132 to the outer surface 148 of movable member 132 in order to allow water, liquid, or other materials to roll off the top of movable member 132. In the illustrative arrangement shown, as one example, when ring 122 is placed such that slots 166 are positioned upward, water may get trapped by ring 122 and will sit on cover 120, but slot 166 provides an egress route for such water (or other liquid or material) to escape so that it is not positioned and/or accumulating top of cover 120.

In cold weather locations, snowplows and/or other machinery may be used to clear snow and ice off of runways, taxiways, aprons, and/or any other surfaces where system 10 is used. In order to protect cover 120 from being scraped and damaged by the snowplows and/or other machinery, ring 122 extends slightly above the top point (in the middle) of movable member 132. In the illustrative arrangement shown, as one example, ring 122 forces the blade of the snowplow, and/or other tools on other machinery, upward so that it does not scrape over the top of, or otherwise contact, moveable member 132 of cover 120 or outlet system 22 in general. In this way, ring 122 prevents cover 120 and outlet system 22 from becoming damaged.

While outlet system 22 and its components have been described according the illustrative arrangement shown, as one example, it will be understood by those skilled in the art that any other configuration of outlet system 22 and/or its components may be used in order to operably connect main pit 20 and allow fuel or other material to be removed from system 10 when desired. The optimal configuration of outlet system 22 and/or the components thereof may vary from one application of system 10 to the next and is therefore in no way limiting to the scope of the present disclosure unless otherwise indicated in the following claims.

### Assembly

In the illustrative arrangement shown, as one example, system 10 is assembled by first assembling the individual components of the inlet system 18, main pit 20, and outlet system 22. The inlet system 18, main pit 20, and outlet system 22 may be assembled in any order. Further, different components of each of inlet system 18, main pit 20, and outlet system 22 may be connected in any different order or manner so long as the outcome remains the same. In one or more illustrative arrangements, as examples, the various components of each of the inlet system 18, main pit 20, and outlet system 22 may be assembled all at once and in any order. What follows is simply one illustrative method of assembly of a system 10 according to the present disclosure, and variations and/or alternatives may occur within the scope of the present disclosure unless otherwise indicated in the following claims.

Inlet System 18: In the illustrative arrangement shown, as one example, inlet system 18 is assembled as follows. However, other assembly methods, components, order of operations, etc. may be used without limitation unless otherwise indicated in the following claims, and the optimal assembly methods, components, order of operations, etc. may depend at least upon the materials of construction. Conduit 30 is cut to a desired length. Fitting 32 is then positioned within conduit 30 such that the steel portion of fitting 32 rests within conduit 30 and the HDPE portion of fitting 32 is also at least partially within conduit 30. The HDPE portion of fitting 32 and conduit 30 are then connected using any method of HDPE connection including fusion, bonding, or welding. In one or more illustrative arrangements, as examples, the HDPE portion of fitting 32 and/or conduit 30 are heated up and the HDPE material of fitting 32 and conduit 30 are fused together. In this way, fitting 32 and conduit 30 are connected. Next, seal 34 is positioned such that it rests within the steep portion of fitting 32. At this point, inlet system 18 is complete.

Main Pit 20: In the illustrative arrangement shown, as one example, main pit 20 is assembled as follows. However, other assembly methods, components, order of operations, etc. may be used without limitation unless otherwise indicated in the following claims, and the optimal assembly methods, components, order of operations, etc. may depend at least upon the materials of construction. In one illustrative arrangement, body 58 may be prefabricated a cylinder with open ends made primarily of HDPE and having a thickness required to meet the specifications for the application for which system 10 is to be employed. Body 58 is cut to the desired length, and material is removed from body 58 in order to create opening 80 in body 58. Material is also removed from top plate 60 in order to create opening 90 in top plate 60. Additionally, holes 68 may be drilled or otherwise machines into bottom plate 56.

Body 58 may then be positioned on top of bottom plate 56 such that body 58 and bottom plate 56 have approximately the same center (i.e., body 58 and bottom plate 56 are approximately concentric circles). Body 58 and bottom plate 56 are then connected using any method of HDPE connection including fusion, bonding, or welding. In one or more illustrative arrangements, as examples, body 58 and bottom plate 56 are connected via HDPE extrusion welding.

A number of gussets 82 are then positioned such that one side of each gusset 82 is flush against bottom plate 56 and another side of each gusset 82 is flush against body 58. Gussets 82 are then connected to both the bottom plate 56 and body 58 using any method of HDPE connection including fusion, bonding, or welding. In one or more illustrative arrangements, as examples, gussets 82 are connected to both the bottom plate 56 and body 58 via HDPE extrusion welding.

Next, the top plate 60 is positioned on top of body 58 such that body 58, bottom plate 56, and top plate 60 have approximately the same center (i.e., top plate 60, body 58, and bottom plate 56 are approximately concentric circles). Top plate 60 is then connected to body 58 using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, body 58 and top plate 60 are connected via HDPE extrusion welding.

Finally, a number of gussets 82 are positioned such that one side of each gusset 82 is flush against top plate 60 and another side of each gusset 82 if flush against body 58. Gussets 82 are then connected to both top plate 60 and body 58 using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, gussets 82 are connected to both the top plate 60 and body 58 via HDPE extrusion welding.

With bottom plate 56, body 58, and top plate 60 operably connected, and gussets 82 also connected to provide structural support, the main pit 20 is assembled.

Outlet System 22: In the illustrative arrangement shown, as one example, outlet system 22 is assembled as follows. However, other assembly methods, components, order of operations, etc. may be used without limitation unless otherwise indicated in the following claims, and the optimal assembly methods, components, order of operations, etc. may depend at least upon the materials of construction. Tabs 100 are connected to the exterior surface 106 of conduit 94 through any means of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, tabs 100 are connected to conduit 94 via HDPE extrusion welding.

Flange 96 is positioned on top of conduit 94 such that flange 96 and conduit 94 have approximately the same center (i.e., flange 96 and conduit 94 are approximately concentric circles). Flange 96 is then connected to conduit 94 through any means of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, flange 96 is connected to conduit 94 via HDPE extrusion welding.

In one or more illustrative arrangements shown, as examples, a raised peripheral edge 116 may be present. Raised peripheral edge 116 may be formed as a part of flange 96, or raised peripheral edge 116 may be a separate part that must be connected to flange 96. In one or more illustrative arrangements, as examples, when raised peripheral edge 116 is a separate component, it is positioned on top of flange 96 adjacent the periphery of flange 96. Raised peripheral edge 116 is then connected to flange 96 using any means of HDPE connection (which may be a direct HDPE-to-HDPE connection forming a watertight, hermetic, nearly hermetic, or other suitable seal between the HDPE components) including fusion, bonding, or welding. In one or more arrangements, as examples, raised peripheral edge 116 is connected to flange 96 via HDPE extrusion welding.

The end of conduit 94 opposite flange 96 is positioned on top of top plate 60 adjacent opening 90 such that conduit 94 and opening 90 have approximately the same center (i.e., conduit 94 and opening 90 are approximately concentric circles). Conduit 94 is then connected to top plate 60 adjacent opening 90 through any means of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, conduit 94 is connected to top plate 60 via HDPE extrusion welding.

Next, a number of gussets 98 are positioned such that one side of each gusset 98 is flush against top side 62 of top plate 60 and another side of each gusset 98 if flush against body conduit 94. Gussets 98 are then connected to both top plate 60 and conduit 94 using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, gussets 98 are connected to both the top plate 60 and conduit 98 via HDPE extrusion welding.

Finally, cover 120 may be connected to outlet system 22 by positioning cover 120 over flange 96 and then extending fasteners, bolts, rods, or any other type of connection member through openings 126 of base member 124 of cover 120 and through holes 114 of flange 96.

Once cover 120 is connected to outlet system 22, ring 122 is placed around the periphery of cover 120 and flange 96 and fasteners, bolts, rods, or any other type of connection member may be placed through holes 164 in ring 122 and through apertures 115 of flange 96. Depending on the weather, ring 122 may be positioned such that slots 166 of ring 122 are positioned upward or downward. In the illustrative arrangement shown, as one example, ring 122 may be positioned such that slots 166 of ring 122 are positioned upward, thereby extending a portion of ring 122 higher than the top of cover 120. In this orientation, ring 122 operates to protect cover 120 by, for example, forcing the blade of a snowplow upward so that it does not scrape the top surface of cover 120, and the slots 166 of ring 122 allow for water to still drain away from cover 120 even when the top of ring 122 extends above the top of cover 120. Alternatively, in warm weather applications, ring 122 may be positioned such that slots 166 of ring 122 are positioned downward and, in this orientation, the top of ring 122 is essentially flush with the adjacent edge of movable member 132 of cover 120, thereby allowing water to run off naturally, without the need for additional slots on the other edge of ring 122.

Alternatively, cover 120 and ring 122 may be connected to outlet system 22 at the location where system 10 is to be installed, and/or after assembling the remainder of system 10, in order for the cover 120 to be placed in the proper orientation at the location where system 10 is installed.

With conduit 94, flange 96, tabs 100, and raised peripheral edge 116 (if present) connected and cover 120 installed, the outlet system 22 is complete.

System 10: With inlet system 18, main pit 20, and outlet system 22 individually assembled, they are ready to be assembled together to form system 10. It will be comprehended by those skilled in the art that inlet system 18, main pit 20, and outlet system 22 may be assembled in any order to form system 10. Additionally, other assembly methods, components, order of operations, etc. may be used without limitation unless otherwise indicated in the following claims, and the optimal assembly methods, components, order of operations, etc. may depend at least upon the materials of construction.

In the illustrative arrangement shown, as one example, inlet system 18 and main pit 20 are connected in the following manner. Conduit 30 of inlet system 18 is positioned such that the hollow interior 44 of conduit 30 and opening 80 of body 58 have approximately the same center (i.e., conduit 30 and opening 80 are approximately concentric circles). In one or more illustrative arrangements, as examples, conduit 30 may be extended partially through opening 80 of body 58 such that a portion of conduit 30 rests within the hollow interior 78 of body 58 of main pit 20. In various alternative arrangements, as examples, conduit 30 may be placed flush against the exterior surface 74 of body 58 of main pit 20. With conduit 30 in the desired position, conduit 30 and main body 58 may be connected using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, conduit 30 is connected to body 58 via HDPE extrusion welding.

Once conduit 30 of inlet system 18 and body 58 of main pit 20 are connected, gussets 36 may be added to provide structural support where inlet system 18 and main pit 20 are connected. In one or more illustrative arrangements, as examples, any number of gussets 36 are positioned such that one side of each gusset 36 is flush against the exterior surface 38 of conduit 30 and another side of each gusset 36 is flush against the exterior surface 74 of body 58. Gussets 36 are then connected to both conduit 30 and body 58 using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, gussets 36 are connected to both conduit 30 and body 58 via HDPE extrusion welding. Once gussets 36 are installed, inlet system 18 and main pit 20 are operably connected.

In the illustrative arrangement shown, as one example, main pit 20 and outlet system 22 are connected in the following manner. Conduit 94 of outlet system 22 is positioned such that the hollow interior 108 of conduit 94 and opening 90 of top plate 60 of main body 20 have approximately the same center (i.e., conduit 94 and opening 90 are approximately concentric circles). In one or more illustrative arrangements, as examples, conduit 94 is placed flush against the top side 86 of top plate 60 of main pit 20. With conduit 94 in the desired position, conduit 94 and top plate 60 may be connected using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, conduit 94 is connected to top plate 60 via HDPE extrusion welding.

Once conduit 94 of outlet system 22 and top plate 60 of main pit 20 are connected, gussets 98 may be added to provide structural support where outlet system 22 and main pit 20 are connected. In one or more illustrative arrangements, as examples, any number of gussets 98 are positioned such that one side of each gusset 98 is flush against the exterior surface 106 of conduit 94 and another side of each gusset 98 is flush against the top side 86 of top plate 60. Gussets 98 are then connected to both conduit 94 and top plate 60 using any method of HDPE connection (which may be a direct HDPE-to-HDPE connection forming a watertight, hermetic, nearly hermetic, or other suitable seal between the HDPE components) including fusion, bonding, or welding. In one or more illustrative arrangements, as examples, gussets 98 are connected to both the conduit 94 and top plate 60 via HDPE extrusion welding. Once gussets 98 are installed, outlet system 22 and main pit 20 are operably connected.

System 10 may be assembled at any time and in any location. That is, in one or more illustrative arrangements, inlet system 18, main pit 20, and outlet system 22 may be assembled at a plant and shipped to the location where system 10 will be installed in one piece. Alternatively, in one or more illustrative arrangements, system 10 may be shipped in component parts and inlet system 18, main pit 20, and outlet system 22 may be assembled together at the location where system 10 is to be installed. Once inlet system 18, main pit 20, and outlet system 22 are operably connected, system 10 is ready to be installed.

### Installation, Use, and Repairs

In various illustrative arrangements, as examples, system 10 is configured to be used at airport gates and/or railroad stations or rail yards. In various illustrative arrangements, as examples, system 10 is installed during the construction of the airport gate and/or railroad station or rail yards. However, other locations, environments, and/or installation procedures may be used with system 10 without limitation unless otherwise indicated in the following claims.

During the construction process, the desired location of system 10 is specified and, once ready, system 10 will be installed at that location. To be installed, a pad is placed on the prepared ground, or the ground where system 10 is to be placed will be planned off such that a flat surface is present. Once the pad or flat surface on the ground is prepared, system 10 can be placed on such position and anchors, bolts, or other securing means and/or components may be placed through holes 68 of bottom plate 56 to secure system 10 in the desired position.

Once system 10 is secured in the desired position, an outside pipe, hose, or other material handling component is extended into and through conduit 30 of inlet system 18 such that the outside pipe, hose, or other material handling component is partially within the hollow interior 78 of body 58 of main pit 20. With the outside pipe, hose, or other material handling component extended through conduit 30, the seal 34 of inlet system 18 is manipulated to engage both the steel portion of fitting 32 and the exterior of the outside pipe, hose, or other material handling component in close and tight tolerances. When seal 34 engages both fitting 32 and outside pipe, hose, or other material handling component in close and tight tolerances, a watertight, environmental, weatherproof, nearly hermetic, hermetic, pressure-tight, and/or otherwise suitable seal is formed, thereby preventing fuel or other material (e.g., other liquid material such as water, other material that may be fluidized such as powders, granules, etc.) from leaking out of system 10, and preventing water or other material from entering into system 10 through inlet system 18.

Valves, hoses, tooling, and/or other components necessary to transfer fuel or other material out of the system 10 then need to be inserted into system 10. This is done by placing the valves, hoses, tooling, or other components through conduit 94 of outlet system 22 and opening 90 of top plate 60 of main pit 20.

At this point, dirt is backfilled around system 10 until the dirt is approximately even with the top plate 60 of main pit 20. Once dirt is backfilled around main pit 20, the runway, taxiway, apron, or other surface is ready to be poured. In one or more illustrative arrangements, as examples, the runway, taxiway, apron, or other surface may be concrete. In alternative arrangements, as examples, the runway, taxiway, apron, or other surface may be tarmac, asphalt, or any other material capable of creating a hard surface for vehicles to travel over. In one or more arrangements, as examples, the concrete, tarmac, asphalt, or other material is poured, but at least a portion of outlet system 22 will rest above the top of the runway, taxiway, apron, or other surface such that it is accessible to operators of system 10.

In the illustrative arrangement shown, as one example, with at least a portion of outlet system 22 positioned above the surface of the runway, taxiway, apron (or other surface for applications of system 10 not at an airport), there may be situations where a heavy load is placed on outlet system 22 (e.g., a plane wheel drives over outlet system 22). When this happens, the load placed on outlet system 22 is transferred to tabs 100, which then operate to transfer at least a portion of such load to the concrete, tarmac, asphalt, or other material that makes up the runway, taxiway, apron, or other surface as described previously herein. In this way, outlet system 22 can tolerate such heavy loads as they occur.

With the concrete, tarmac, asphalt, or other material poured, system 10 is ready to operate. Fuel or other material can be sent through the outside pipe, hose, or other material handling component, which extends through conduit 30 of inlet system 18. This fuel or other material flows through the outside pipe, hose, or other material handling component and into the hollow interior 78 of body 58 of main pit 20. The fuel or other material can fill the hollow interior 78 of body 58 and the fuel or other material will be retained within main pit 20 until it is ready to be pumped out and/or otherwise removed.

When fuel or other material needs to be removed from main pit 20, an operator may open cover 120 and operate the valves, hoses, other tooling, and/or other components within system 10 to remove fuel or other material up and out of system 10 through outlet system 22. Once the desired amount of fuel or other material has been removed, the operator may close the valves, or otherwise operate the valves, hoses, other tooling, and/or other components to stop the flow of fuel or other material and cover 120 of outlet system 22 may be closed.

At times, system 10 may need repairs. Due to the nature of system 10, repair of system 10 is relatively easy, simple, and quick. First, system 10 is drained of the fuel or other material. Then, an operator can enter system 10 by opening cover 120 on outlet system 22 and entering system 10 through the hollow interior 108 of conduit 94 and the opening 90 of top plate 60, thereby entering the hollow interior 78 of body 58 of main pit 20. The operator can bring an HDPE patch which is sized and shaped to address the issue within main pit 20. The operator can then connect the HDPE patch to the existing system 10 through any means of HDPE connection (which may be a direct HDPE-to-HDPE connection forming a watertight, hermetic, nearly hermetic, or other suitable seal between the HDPE components) including fusion, bonding, or welding. Due to the nature, ease, and sealing capabilities of HDPE connection, the repair of system 10, when certain components thereof are formed primarily of HDPE material, is simply, easy, quick, safe, and effective. Other repair methods may be used when certain components of system 10 are formed primarily of HDPE<and still other repair methods may be used when certain components of system 10 are formed of a material other than HDPE without limitation unless otherwise indicated in the following claims.

Any of the HDPE connections discussed herein may use any suitable process for connecting one HDPE member to another HDPE member either currently known or later developed without limitation unless otherwise indicated in the following claims. It is contemplated that for at least some applications of system 10 heat fusion, electrofusion of a specific fitting, or spin welding may be used, but without limitation unless otherwise indicated in the following claims.

### Additional Utility Pit System 10 Embodiments

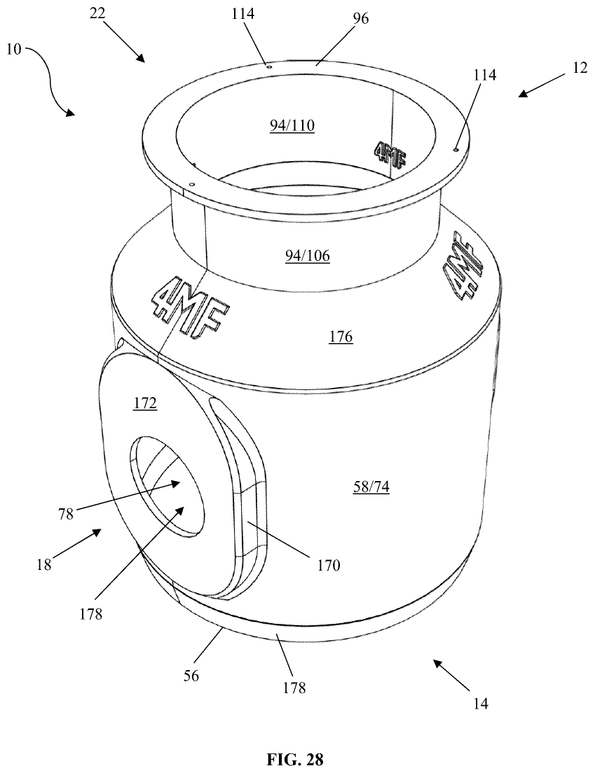

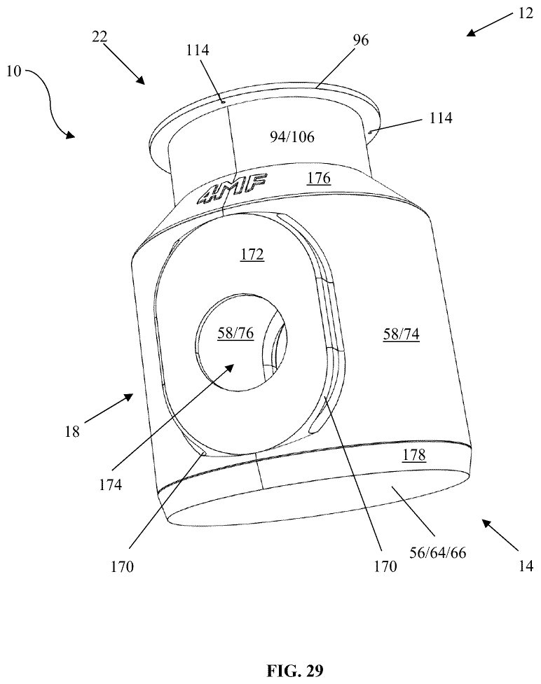

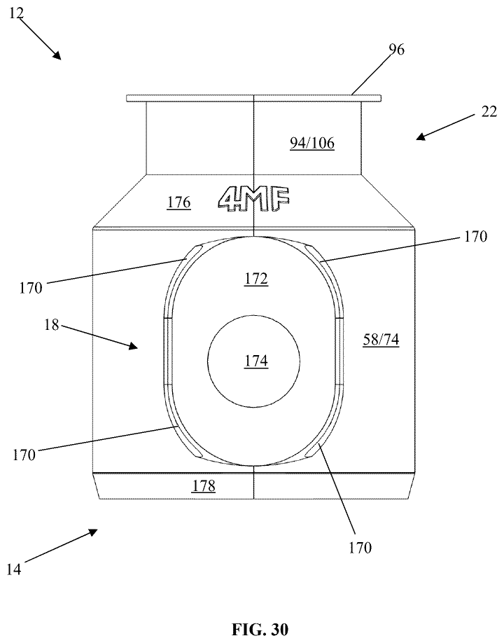

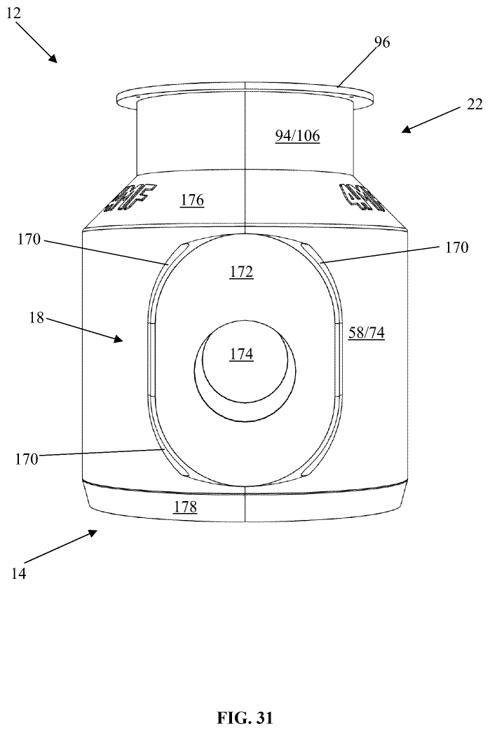

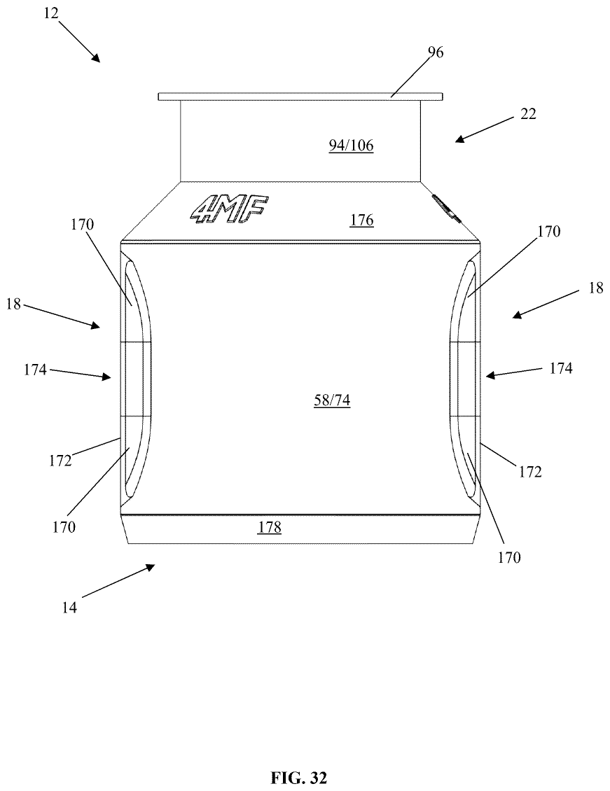

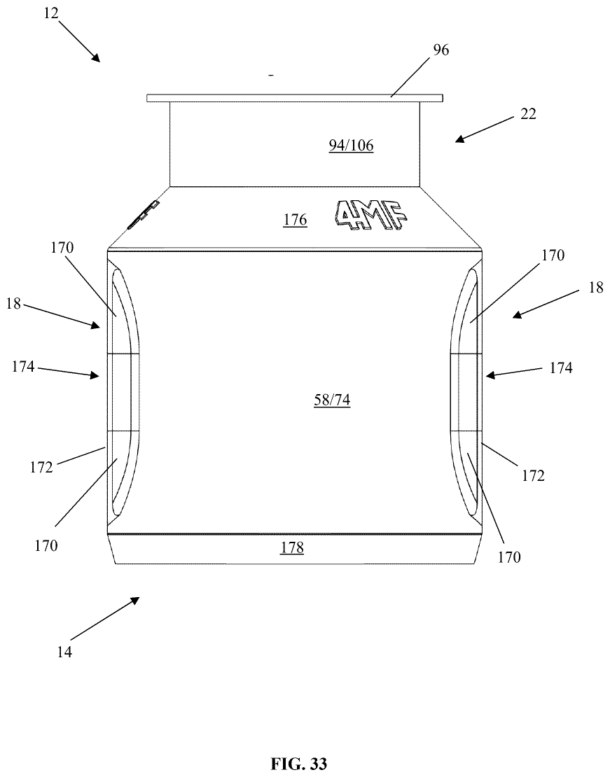

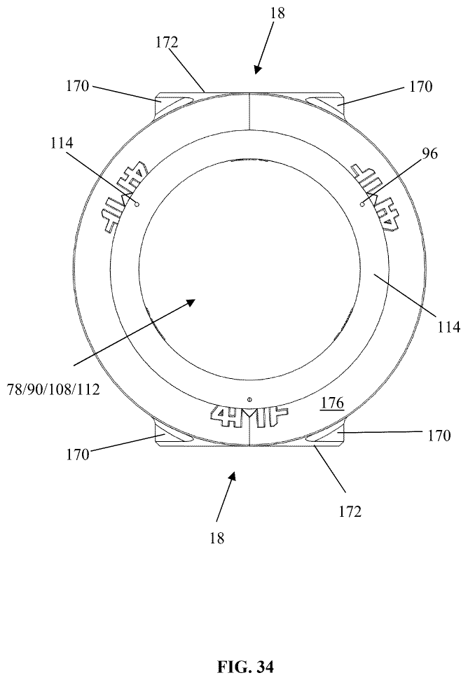

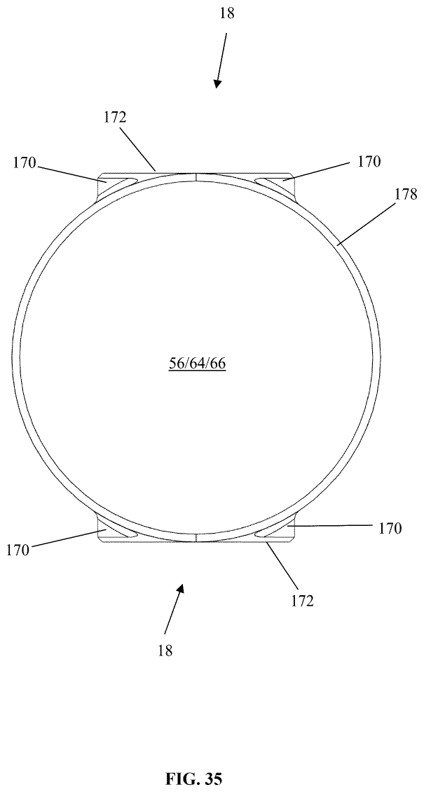

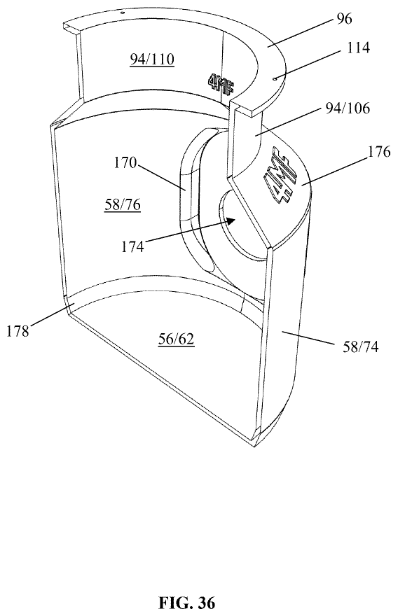

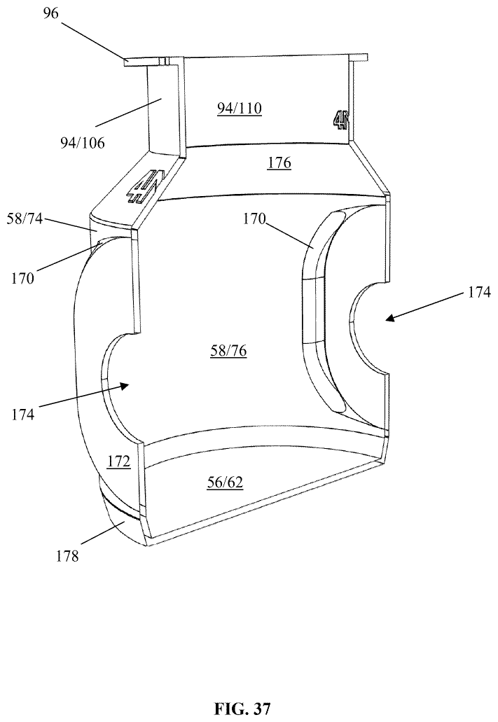

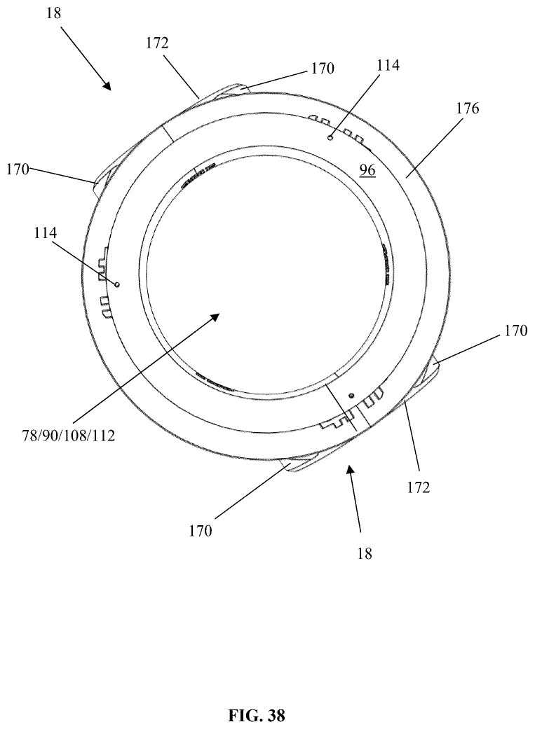

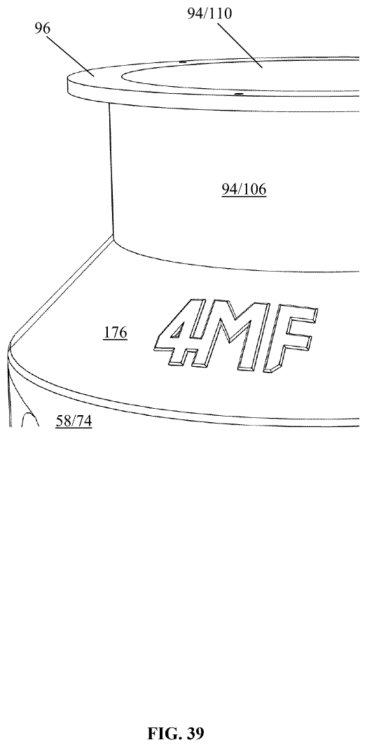

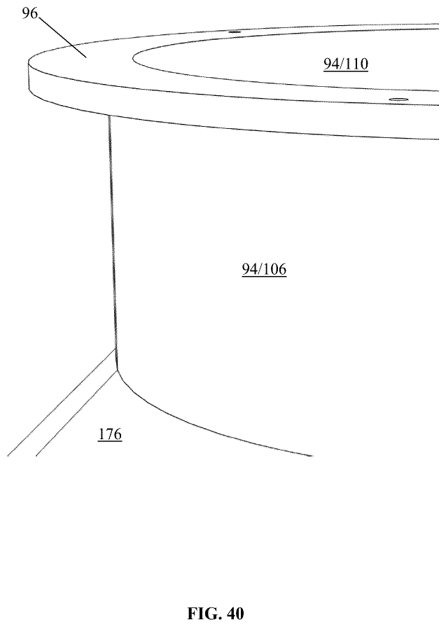

In another illustrative arrangement/embodiment as shown in FIGS. 28-40, as an example, system 10, may include two inlet systems 18 engaged with body 58 on opposite sides thereof and outlet system 22 engaged with a top end 70 of body 58. It is contemplated that this (and various other) illustrative arrangements/embodiments of system 10 disclosed herein may be especially useful in an airport environment for secondary fuel containment, but the scope of the present disclosure is not so limited unless otherwise indicated in the following claims. While such an arrangement/embodiment of system 10 is described according to the arrangements/embodiments shown, as one example, any combination or arrangement may be used and is hereby contemplated for use.

### Inlet System 18

In another illustrative arrangement shown, as one example, system 10 includes an inlet system 18 on opposite sides of main body 58. Inlet system 18 is formed of any suitable size, shape, and design and in the illustrative embodiments is configured to allow fuel or other material (e.g., other liquid material such as water, other material that may be fluidized such as powders, granules, etc.) from an outside source to enter main pit 20 and/or interior 78 of body 58 of system 10. However, other illustrative arrangements of system 10 otherwise configured such as that shown in FIGS. 28-40 may include only one inlet system 18 without limitation unless otherwise indicated in the following claims.

In the illustrative arrangement shown, as one example, inlet system 18 includes a reinforcement portion 170 on exterior surface 74 of body 58. Reinforcement portion 170 and/or various components thereof may be integrally formed with body 58 as a single, unitary member that may be formed of a manufacturing process such as machining, extrusion, forming, molding, additive manufacturing, or the like to form a unitary and monolithic member. Alternatively, body 58 and reinforcement portion 170 may be formed of multiple pieces that are connected or assembled to one another through fusing, bonding, welding, friction fitting, or the like. Accordingly, the scope of the present disclosure is not limited to the specific manufacturing process and/or method used to construct body 58, reinforcement portion 170, and/or components thereof but extends to all known or later-developed manufacturing processes and/or methods without limitation unless otherwise indicated in the following claims.

Reinforcement portion 170 includes aperture 174 therein that provides access from exterior surface 74 of body 58 to interior 78 of body 58. Aperture 174 may be circular in shape and positioned in the approximate geometric center of planar exterior 174. However, in other illustrative arrangement/embodiments aperture(s) 174 may be differently configured, sized, positioned, shaped, etc. without departing from the scope of the present disclosure unless otherwise indicated in the following claims.

Reinforcement portion 170 also includes planar exterior 172. Planar exterior 172 may be coplanar with a vertically oriented plane that is tangent to exterior surface 74 of body 58. Generally, the shape of planar exterior may be oval, ellipse, or obround, but any suitable shape for planar exterior 172 may be used without limitation unless otherwise indicated in the following claims.

In certain illustrative arrangements, and as shown in some illustrative arrangements herein as an example, another planar exterior 172 in a second inlet system 18 may reside in a corresponding parallel plane at a tangent point that is 180 degrees offset from the first vertically oriented plane. When so configured, system 10 includes two inlet systems 18 having apertures 174 that are concentric, spaced apart by a distance approximately equal to the diameter of body 58, and residing in parallel planes that are vertically oriented. However, system 10, inlet system(s) 18, and/or components thereof may be differently configured without limitation unless otherwise indicated in the following claims.

It is contemplated that for most applications of system 10, the connection points/transitions from body 58 to inlet system 18 and/or components thereof 56 will be configured with the appropriate sealing capability for a given material. In certain illustrative arrangements these seals may be watertight, environmental, weatherproof, nearly hermetic, hermetic, pressure-tight, and/or otherwise suitable seal.

Top end 70 of body 58 is engaged with upper frustum 176. While a first end of upper frustum 176 is engaged with top end 70 of body 58, a second end of upper frustum 176 is engaged with lower end 102 of conduit 94. Upper end 104 of conduit 94 is engaged with flange 96. Bottom end 72 of body 58 is engaged with lower frustum 178. While a first end of lower frustum 178 is engaged with bottom end 72 of body 58, a second end of lower frustum 178 is engaged with bottom plate 56. Bottom plate 56, body 58, upper conduit 94, flange 96, upper frustum 176, lower frustum 178, and/or various components thereof may be integrally formed with one another as a single, unitary member that may be formed of a manufacturing process such as machining, extrusion, forming, molding, additive manufacturing, or the like to form a unitary and monolithic member. It is contemplated that for certain illustrative arrangements/embodiments of system 10 wherein multiple components of system 10 are integrally formed as a single, unitary member an injection molding technique or thermoforming technique may be employed. However, any suitable manufacturing technique currently known or later developed may be used without limitation unless otherwise indicated in the following claims.

Alternatively, bottom plate 56, body 58, conduit 94, flange 96, upper frustum 176, lower frustum 178, and/or various components thereof may be formed of multiple pieces that are connected or assembled to one another through fusing, bonding, welding, friction fitting, or the like. Accordingly, the scope of the present disclosure is not limited to the specific manufacturing process and/or method used to construct bottom plate 56, body 58, conduit 94, flange 96, upper frustum 176, lower frustum 178, and/or components thereof but extends to all known or later-developed manufacturing processes and/or methods without limitation unless otherwise indicated in the following claims.

It is contemplated that for most applications of system 10, the connection points/transitions from flange 96 to conduit 94, from conduit 94 to upper frustum 176, from upper frustum 176 to body 58, from body 58 to lower frustum 178, and from lower frustum 178 to bottom plate 56 will be configured with the appropriate sealing capability for a given material. In certain illustrative arrangements these seals may be watertight, environmental, weatherproof, nearly hermetic, hermetic, pressure-tight, and/or otherwise suitable seal.

In one illustrative arrangement of a system 10, as an example, the diameter of flange 96 and conduit 94 may be larger than those of the prior art and/or industry standard. Such an increase in size will allow operators to more easily access any interior components/surfaces of system 10 for assembly, repairs, service, inspection, etc. without limitation unless otherwise indicated in the following claims. Additionally, for one illustrative arrangement of system 10, as an example, upper frustrum 176, which may be formed in a molding manufacturing process for system 10, may cooperate with other features/components of system 10 to facilitate a more spacious work environment within outlet system 22 and/or interior 78 of body 58 and access thereto for assembly, inspection, servicing, etc. without limitation unless otherwise indicated in the following claims.

In an illustrative arrangement of system 10 shown, as an example, all components of system 10 may be constructed of high-grade high-density polyethylene (HDPE) molded integrally with one another as a single, unitary member. Such an arrangement results in direct HDPE-to-HDPE connections of various components (e.g., the connection of inlet system 18 to body 58, the connection of outlet system 22 to body 58, etc.) allows any seal/transition between two components/features of system 10 to be designed to a specific standard, and such seal/transitions may be configured as watertight, environmental, weatherproof, nearly hermetic, hermetic, pressure-tight, and/or otherwise suitable seal during the fabrication process of system 10 without limitation unless otherwise indicated in the following claims.

Any suitable molding process may be used, either currently know (such as rotational molding, blow molding, injection molding, and/or combinations thereof) or later developed without limitation unless otherwise indicated in the following claims. It is contemplated that for at least some applications of various illustrative arrangements/embodiments of system 10 shown herein, as examples, constructing outlet system 22 and various components thereof, upper frustum 176, body 58, inlet system(s) 18 and various components thereof, lower frustum 178, and bottom plate 56 of HDPE will result in a more durable and structurally sound design even in sections of components of system 10 having reduced thickness. The increased durability and structural integrity may mitigate and/or eliminate breakage and result in less downtime of system 10.

Furthermore, in the event of damage, a system 10 so configured utilizing HDPE may be very user friendly to repair and may be repaired using known techniques (including but not limited a handheld HDPE fusion device unless otherwise indicated in the following claims), without removing system 10 from its installation location. The ability to repair system 10 and/or a component thereof at the installation site will also reduce costs because repair may not require excavation of the system 10 and/or component, and instead repair may be conducted in situ. It is contemplated that in the future, repairs may be accomplished through technology providing localized and concentrated heat to a specific area of system 10.

Utilizing a molded HDPE arrangement/embodiment of system 10 as shown herein may also result in a lower-weight system 10 compared to the prior art and even compared to fully fabricated versions of other HDPE arrangements/embodiments of system 10. It is contemplated that these HDPE arrangements/embodiments of system 10 may allow future onsite manufacturing utilizing additive manufacturing techniques and onsite repairs utilizing laser-heating techniques. It is also contemplated that HDPE arrangements/embodiments of system 10 will result in a longer product life cycle compared to the prior art. These and other advantages/features of constructing system 10 and/or various components thereof from a high-quality HDPE material may become apparent to those skilled in the art in light of the present disclosure, and the specific advantages/features of same are in no way limiting to the scope of the present disclosure unless otherwise indicated in the following claims.

For arrangements/embodiments of system 10 utilizing a molded HDPE configuration, other material-handling components (e.g., valves, pipes, fittings, etc.) required to move material into or out of system 10 may be constructed of any suitable material, such as metals and their alloys, polymers, etc. Other material-handling components may be engaged with the desired portion/component of system 10 through any suitable method and/or structure without limitation unless otherwise indicated in the following claims. For at least some applications of system 10 it is contemplated that such engagement may be accomplished through flange connections, electrofusion fittings, compression fittings, or butt fusion fittings. However, any suitable engagement method and/or components may be used either currently known or later developed without limitation unless otherwise indicated in the following claims.

In another configuration of system 10, as an example, it is contemplated that an existing component of a fuel system may be coated with an HDPE liner, such as the interior surface of a utility pit constructed of metal, a metallic pipe, etc. An HDPE liner may be applied through any suitable method, such as a spray-in liner without limitation unless otherwise indicated in the following claims.

From the above discussion it will be appreciated that a system 10 is presented herein that improves upon the state of the art. Specifically, in one or more illustrative arrangements, a system 10 is presented which: is durable; is easy to install; is easy to repair; is inexpensive to repair; is safe to repair; is safe to clean; is relatively easy to clean; is relatively easy and inexpensive to build; can be built relatively quickly and efficiently; is relatively cost friendly to manufacture; is relatively easy to transport; is robust; is water resistant; is cost effective; is not easily susceptible to wear and tear; has a long useful life; is efficient to use and operate; and/or has other advantages either inherently or explicitly disclosed herein.

Having described preferred aspects and embodiments of the various systems, apparatuses, arrangements, components, and methods of the present disclosure, other features of the present disclosure will undoubtedly occur to those versed in the art, as will numerous modifications and alterations in the embodiments, arrangements, components, and/or methods as illustrated herein, all of which may be achieved without departing from the spirit and scope of the present disclosure. Accordingly, the embodiments, arrangements, components, and methods pictured and described herein are for illustrative purposes only, and the scope of the present disclosure extends to all embodiments, arrangements, components, and/or methods for providing the various benefits and/or features of the present disclosure unless so indicated in the following claims.

While the embodiments, arrangements, components, and methods of the present disclosure have been described in connection with preferred embodiments, arrangements, components, and methods and specific examples of same, it is not intended that the scope be limited to the particular embodiments and/or arrangements set forth, as the embodiments and/or arrangements herein are intended in all respects to be illustrative rather than restrictive unless otherwise indicated in the following claims. Accordingly, the embodiments, arrangements, components, and methods pictured and described herein are in no way limiting to the scope of the present disclosure unless so stated in the following claims.

Although several figures are drawn to accurate scale, any dimensions provided herein are for illustrative purposes only and in no way limit the scope of the present disclosure unless so indicated in the following claims. It should be noted that the embodiments, arrangements, components, and methods described herein are not limited to the specific illustrative examples pictured and described herein, but rather the scope of the inventive features according to the present disclosure is defined by the claims herein. Modifications and alterations from the described embodiments, arrangements, components, and methods will occur to those skilled in the art without departure from the spirit and scope of the present disclosure.

Any of the various features, components, functionalities, advantages, aspects, configurations, process steps, methods, method steps, etc., from various arrangements/embodiments may be used alone or in combination with one another depending on the compatibility of the features, components, functionalities, advantages, aspects, configurations, process steps, methods, method steps, etc. Accordingly, a nearly infinite number of variations of the present disclosure exist. Modifications and/or substitutions of one or more features, components, functionalities, advantages, aspects, configurations, process steps, methods, method steps, etc. for another in no way limit the scope of the present disclosure unless so indicated in the following claims.

It is understood that the present disclosure extends to all alternative combinations of one or more of the individual features, process steps, and/or components mentioned, evident from the text and/or drawings, and/or inherently disclosed. All of these different combinations constitute various alternative aspects of the present disclosure and/or components thereof. The embodiments described herein explain the best modes known for practicing the inventive features of the present disclosure and will enable others skilled in the art to utilize the same. The claims are to be construed to include alternative embodiments to the extent permitted by the prior art.

Unless otherwise expressly stated in the claims, it is in no way intended that any process or method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including but not limited to: matters of logic with respect to arrangement of steps or operational flow; plain meaning derived from grammatical organization or punctuation; the number or type of embodiments described in the specification.

What is claimed:

1. A utility pit system comprising:
an inlet system;
wherein the inlet system is formed primarily of high-density polyethylene (HDPE);
a main pit;
wherein the main pit is formed primarily of HDPE;
an outlet system;
wherein the outlet system is formed primarily of HDPE;
wherein the inlet system is configured to operably connect to the main pit through a direct HDPE-to-HDPE connection, the direct connection forming a seal therebetween that is at least watertight; and,
wherein the main pit is configured to operably connect to the outlet system through a second direct HDPE-to-HDPE connection, the second direct connection forming a seal therebetween that is at least watertight.

2. The system of claim 1, wherein the system is configured to contain fuel.

3. The system of claim 1, further comprising:
the outlet system having a flange; and,
the outlet system having a conduit with a first end and a second end, the first end connected to the main pit at the second direct HDPE-to-HDPE connection and the second end connected to the flange.

4. The system of claim 1, further comprising:
the outlet system having a conduit;
the outlet system having a plurality of tabs affixed to an exterior surface of the conduit and positioned between a first end and a second end of the conduit.

5. The system of claim 1, further comprising:
the main pit having a top plate;
the main pit having a body;
the main pit having a bottom plate;
the inlet system having a conduit; and,
the inlet system having a seal.

6. The system of claim 1, further comprising:
the outlet system having a flange;
the outlet system having a conduit;
the main pit having a top plate;
the top plate having an opening;
the main pit having a body;
the body having an opening;
the main pit having a bottom plate;
the inlet system having a conduit;
the inlet system having a seal;
wherein the conduit of the outlet system is configured to operably connect to the opening of the top plate of the main pit at the second direct HDPE-to-HDPE connection; and,
wherein the conduit of the inlet system is configured to operably connect to the opening of the body of the main pit at the direct HDPE-to-HDPE connection.

7. The system of claim 1, wherein the inlet system is operably connected to the main pit at the direct HDPE-to-HDPE connection by HDPE fusion and wherein the main pit is operably connected to the outlet system at the second direction HDPE-to-HDPE connection by HDPE fusion.

8. The system of claim 1, wherein the inlet system is operably connected to the main pit at the direct HDPE-to-HDPE connection by HDPE bonding and wherein the main pit is operably connected to the outlet system at the second direct HDPE-to-HDPE connection by HDPE bonding.

9. The system of claim 1, wherein the inlet system is operably connected to the main pit at the direct HDPE-to-HDPE connection by HDPE welding and wherein the main pit is operably connected to the outlet system at the second direct HDPE-to-HDPE connection by HDPE welding.

10. The system of claim 1, wherein the outlet system, inlet system, and the main pit are watertight.

11. The system of claim 1, wherein the seal between the inlet system and the main pit is a hermetic or nearly hermetic seal.

12. The system of claim 1, wherein the seal between the outlet system and the main pit is a hermetic or nearly hermetic seal.

13. The system of claim 1, wherein the direct HDPE-to-HDPE connection and the second direct HDPE-to-HDPE connection each form a hermetic or nearly hermetic seal, respectively.

14. The system of claim 1, wherein the direct HDPE-to-HDPE connection and the second direct HDPE-to-HDPE connection each form an environmental seal, respectively.

15. A utility pit system comprising:
an inlet system;
wherein the inlet system is formed primarily of high-density polyethylene (HDPE);
a main pit;
wherein the main pit is formed primarily of HDPE;
wherein the main pit is configured to operably connect to the inlet system to form a hermetic or nearly hermetic seal therebetween;
an outlet system;
wherein the outlet system is formed primarily of HDPE;
wherein the outlet system is configured to operably connect to the main pit to form a hermetic or nearly hermetic seal therebetween;
wherein the inlet system is configured to allow a liquid material to enter into the main pit;
wherein the main pit is configured to retain the liquid material; and,
wherein the outlet system is configured to allow the liquid material to exit the pit system.

16. The system of claim 15, further comprising:
the outlet system having a flange;
the outlet system having a conduit with a first end and a second end, the first end connected to the main pit at a direct HDPE-to-HDPE connection forming the hermetic or nearly hermetic seal therebetween and the second end connected to the flange; and,
the outlet system having a plurality of tabs affixed to an exterior surface of the conduit and positioned between the first end and the second end of the conduit.

17. The system of claim 15, further comprising:
the hermetic or nearly hermetic seal between the inlet system and the main pit is formed through a second direct HDPE-to-HDPE connection.

18. The system of claim 15, further comprising:
the main pit having a body;
the main pit having a bottom plate engaged with a first end of the body;
the main pit having a top plate engaged with a second end of the body;
the inlet system having a conduit; and,
the inlet system having a seal.

19. The system of claim 15, further comprising:
the main pit having a top plate;
the top plate having an opening;
the main pit having a body engaged with the top plate;
the body having an opening;
the main pit having a bottom plate engaged with the body opposite the top plate;
the outlet system having a flange;
the outlet system having a conduit with a first end and a second end, the first end connected to the main pit at a direct HDPE-to-HDPE connection in the opening of the top plate to form the hermetic or nearly hermetic seal between the outlet system and the main pit and the second end connected to the flange;
the outlet system having a plurality of tabs affixed to an exterior surface of the conduit and positioned between the first end and the second end of the conduit;
the inlet system having a conduit; and,
wherein the conduit of the inlet system is configured to operably connect to the opening of the body of the main pit at a second direct HDPE-to-HDPE connection forming the hermetic or nearly hermetic seal between the inlet system and the main pit.

20. The system of claim 15, further comprising:
the outlet system having a flange; and,
wherein a manhole cover is operably connected to the flange is configured to move between a closed position and an open position.

21. The system of claim 15, wherein the inlet system is operably connected to the main pit by HDPE fusion and wherein the main pit is operably connected to the outlet system by HDPE fusion.

22. The system of claim 15, wherein the inlet system is operably connected to the main pit by HDPE bonding and wherein the main pit is operably connected to the outlet system by HDPE bonding.

23. The system of claim 15, wherein the inlet system is operably connected to the main pit by HDPE welding and wherein the main pit is operably connected to the outlet system by HDPE welding.

24. The system of claim 15, wherein the system is positioned under a taxiway or apron surface at an airport.

25. The system of claim 15, wherein the system is manufactured through a molding process wherein the inlet system, the main pit, and the outlet system are integrally formed as a single, unitary member.

26. A utility pit system comprising:
an inlet system;
wherein the inlet system is formed primarily of high-density polyethylene (HDPE);
wherein the inlet system has a conduit having a first end and a second end;
a main pit;
wherein the main pit is formed primarily of HDPE;
wherein the main pit has a top plate connected to a first end of a body and a bottom plate connected to a second end of the body;
wherein a first opening is formed in the body and a second opening is formed in the top plate;
wherein the main pit is configured to operably connect to the inlet system to form a seal between the first end of the conduit of the inlet system and the first opening in the body;
an outlet system;
wherein the outlet system is formed primarily of HDPE;
wherein the outlet system has a conduit having a first end and a second end; and,
wherein the outlet system is configured to operably connect to the main pit to form a seal between the first end of the conduit of the outlet system and the second opening formed in the top plate.

27. The system of claim 26, further comprising:
wherein the inlet system is configured to allow a liquid material to enter into the main pit;
wherein the main pit is configured to retain the liquid material; and,
wherein the outlet system is configured to allow the liquid material to exit the pit system.

28. The system of claim 26, further comprising:
a first gusset engaged with both the top plate and the body; and,
a second gusset engaged both with the bottom plate and the body.

29. The system of claim 26, further comprising:
a third gusset engaged with both the top plate and the conduit of the outlet system; and,
a fourth gusset engaged both with the body of the main pit and the conduit of the inlet system.

30. The system of claim 26, wherein the seal between the inlet system and the main pit is a watertight seal and the seal between the outlet system and the main pit is a watertight seal.

31. The system of claim 26, wherein the seal between the inlet system and the main pit is a nearly hermetic seal and the seal between the outlet system and the main pit is a nearly hermetic seal.

32. The system of claim 26, wherein the seal between the inlet system and the main pit is a hermetic seal and the seal between the outlet system and the main pit is a hermetic seal.

33. The system of claim 26, wherein the seal between the inlet system and the main pit is a pressure-tight seal and the seal between the outlet system and the main pit is a pressure-tight seal.

34. A utility pit system comprising:
a main pit;
wherein the main pit is formed primarily of HDPE;
an outlet system;
the outlet system having a flange;
wherein the outlet system is formed primarily of HDPE;
wherein the main pit is configured to operably connect to the outlet system by any means of HDPE connection;
a manhole cover;
wherein the manhole cover is formed primarily of metallic material;
wherein the manhole cover is operably connected to the flange;
wherein the manhole cover is configured to move between a closed position and an open position;
a ring;
wherein the ring is formed primarily of metallic material; and,
wherein the ring is positioned around a periphery of the flange of the outlet system and around a periphery of the manhole cover.

35. The system of claim 34, wherein the ring is configured to protect the manhole cover and the flange of the outlet system.

36. The system of claim 34, wherein the manhole cover is configured to be flush or nearly flush with a surrounding surface when the manhole cover is in the closed position.

37. The system of claim 34, wherein the ring includes a groove, wherein the groove is configured to allow liquid to drain from an interior of the ring.

38. The system of claim 34, wherein the system is positioned under a taxiway or apron surface at an airport.

39. A method of constructing a utility pit, the method comprising:
providing a prefabricated body for a main pit, the prefabricated body being cylindrical in shape with open ends, the prefabricated body being formed primarily of a high-density polyethylene (HDPE) material;
cutting the body to a desired length;
removing a portion of material from the body to create an opening therein;
securing a bottom plate to a first end of the body to form a direct HDPE-to-HDPE connection and thereby forming a hermetic or nearly hermetic seal between the bottom plate and the body;
removing a portion of material from a top plate to create an opening therein;
securing the top plate to a second end of the body to form a second direct HDPE-to-HDPE connection and thereby forming a hermetic or nearly hermetic seal between the top plate and the body;
cutting a first conduit to a desired length wherein the conduit is formed primarily of the HDPE material;
securing a fitting to the first portion of conduit, wherein a first portion of the fitting is formed primarily of a metal material and a second portion of the fitting is formed primarily of the HDPE material, and wherein the first portion of the fitting and part of the second portion of the fitting rest within the first conduit;
securing the second portion of the fitting to the conduit to form a third direct HDPE-to-HDPE connection and thereby forming a hermetic or nearly hermetic seal between the second portion of the fitting and the first conduit;
cutting a second conduit to a desired length, wherein the conduit is formed primarily of the HDPE material;
securing a plurality of tabs to an exterior surface of the second conduit;
connecting a flange to a first end of the second conduit, wherein the flange is formed primarily of the HDPE material;
connecting a second end of the second conduit to the top plate adjacent the opening in the top plate; and,
positioning a cover over the flange.

40. The method of claim 39, further comprising:
securing at least one gusset to both the top plate and the body adjacent the second end of the body; and,
securing at least one gusset to both the bottom plate and the body adjacent the first end of the body.

41. The method of claim 39, further comprising:
fashioning at least one hole in the top plate; and,
fashioning at least one hole in the bottom plate.

42. The method of claim 39, wherein the flange has a raised peripheral edge.
